(19) United States
(12) Patent Application Publication
(10) Pub. No.: US 2003/0104923 A1
(43) Pub. Date: Jun. 5, 2003

(54) Niobium oxide powder, niobium oxide sintered body and capacitor using the sintered body

(75) Inventors: Kazuhiro Omori, Kanagawa (JP); Kazumi Naito, Chiba (JP); Toshiya Kawasaki, Kanagawa (JP); Kouichi Wada, Kanagawa (JP)

Correspondence Address: SUGHRUE MION, PLLC, 2100 Pennsylvania Avenue, NW, Washington, DC, 20037-3213, US

(73) Assignee: SHOWA DENKO K.K.

(21) Appl. No.: 10/144,861

(22) Filed: May 15, 2002

Related U.S. Application Data
(60) Provisional application No. 60/291,925, filed on May 21, 2001.
(60) Provisional application No. 60/331,200, filed on Nov. 9, 2001.

(30) Foreign Application Priority Data
May 15, 2001 (JP) P2001-145571
Nov. 6, 2001 (JP) P2001-340318

(51) Int. Cl. C01G 33/00; C04B 35/495

(52) U.S. Cl. 501/134; 423/592

(57) ABSTRACT

(1) A niobium monoxide powder for capacitors, which is represented by the formula: NbOx (x=0.8 to 1.2), may contain from 50 to 200,000 ppm of other element, and has a tapping density of 0.5 to 2.5 g/ml, an average particle size of 10 to 1,000 μm, an angle of repose of 10 to 60°, a BET specific surface area of 0.5 to 40 m²/g and a plurality of pore diameter peak tops in the pore distribution, and a production method thereof; (2) a niobium monoxide sintered body obtained by sintering the niobium monoxide powder, which has a plurality of pore diameter peak tops in the range from 0.01 to 500 μm, wherein preferably, out of the plurality of pore diameter peak tops, peak tops of two peaks having a highest relative intensity are present in the range from 0.2 to 0.7 μm and in the range from 0.7 to 3 μm, respectively, and the peak top of the peak having a highest relative intensity is present in the larger diameter side than the peak top of the peak having a next highest relative intensity, and a production method thereof; (3) a capacitor using the sintered body, and a production method thereof; and (4) an electronic circuit and an electronic instrument each using the capacitor.

### CROSS REFERENCE TO RELATED APPLICATIONS

This application is an application filed under 35 U.S.C. §111(a) claiming benefit pursuant to 35 U.S.C. §119(e)(1) of the filing date of the Provisional Application No. 60/291,925 filed May 21, 2001 and the Provisional Application No. 60/331,200 filed Nov. 9, 2001 pursuant to 35 U.S.C. §111(b).

### TECHNICAL FIELD

The present invention relates to a niobium monoxide powder and a sintered body thereof, which can stably produce a capacitor having a large capacitance per unit mass, a low equivalent series resistance (ESR), good leakage current characteristics and excellent moisture resistance, and also relates to a capacitor using the sintered body and production methods of these niobium monoxide powder, niobium monoxide sintered body and capacitor.

### BACKGROUND ART

Capacitors for use in electronic instruments such as potable telephone and personal computer are demanded to have a small size and a large capacitance. Among these capacitors, a tantalum capacitor is preferred because of its large capacitance for the size and good performance.

Furthermore, recent electronic devices are demanded to work at a low voltage, work at a high frequency and generate low noise and therefore, solid electrolytic devices are also demanded to have lower ESR (equivalent series resistance).

In the tantalum capacitor, a sintered body of tantalum powder is generally used as the anode material. This powder is molded and then sintered, whereby the powder is integrated and works out to an electrode called a sintered body. The inside of this sintered body takes a three-dimensional complicated form resulting from the powders being electrically and mechanically connected with each other. On the surface of this sintered body including the surface of inner voids, a dielectric film layer is formed and thereinto, a material as a counter electrode is impregnated, whereby a capacitor is manufactured. As long as the dielectric film layer uniformly adheres to the inner and outer surfaces of the sintered body, the capacitance of the capacitor manufactured greatly depends on, microscopically, the contact state of the counter electrode material with the dielectric film layer.

In order to increase the capacitance of the tantalum capacitor, it is necessary to increase the mass of the sintered body or to use a sintered body increased in the surface area by pulverizing the tantalum powder.

The method of increasing the mass of the sintered body necessarily involves enlargement of the capacitor shape and cannot satisfy the requirement for downsizing. On the other hand, in the method of pulverizing tantalum powder to increase the specific surface area, the pore diameter of the tantalum sintered body decreases or closed pores increase at the stage of sintering, as a result, impregnation of the cathode agent in the later step becomes difficult.

For example, assuming that when an aqueous phosphoric acid solution is used as a counter electrode material, the contact state with the dielectric film layer is complete and the capacitance appearance ratio (also called a cathode agent impregnation ratio) at this time is 100%, a capacitance appearance ratio of 100% can be hardly attained in the case of using an electrode material having high viscosity, particularly a solid electrode material. In particular, when the average particle size of tantalum powder is small or the sintered body manufactured from tantalum powder has a large shape, the difficulty increases and in an extreme case, the capacitance appearance ratio cannot reach even 50%. With such a low capacitance appearance ratio, the capacitor manufactured cannot have a sufficiently high moisture resistance.

In the case where the tantalum powder for the manufacture of a tantalum sintered body has a small pore size, the pore size of the sintered body is necessarily small and the capacitance appearance ratio decreases. As a result, there arises a problem that low ESR cannot be attained. As one of means for solving these problems, it may be considered to manufacture a sintered body capable of giving a high capacitance appearance ratio by using an electrode material capable of providing a dielectric material having a dielectric constant larger than that of tantalum and manufacture a capacitor by using the sintered body.

As for such an electrode material which can be supplied in industry, niobium having a dielectric constant larger than that of tantalum and having a large reserve is known.

JP-A-55-15722 (the term “JP-A” as used herein means an “unexamined published Japanese patent application”) discloses a method for producing a sintered device for capacitors, where agglomerated powder is molded under pressure into valve-acting metal fine powder having a particle size of 2.0 μm or less, the fine powder is sintered, the molded and sintered body is cut into fine pieces, a lead part is joined therewith and these are again sintered. However, details on the production method and properties of a capacitor are not described in this patent publication.

U.S. Pat. No. 4,084,965 discloses a capacitor using a sintered body of niobium powder having an average particle size of 5.1 μm obtained by hydrogenating and pulverizing a niobium ingot. However, the capacitor disclosed has a large leakage current (hereinafter sometimes simply referred to as “LC”) value and the practicability thereof is low.

JP-A-10-242004 discloses a technique of partially nitriding a niobium powder and thereby improving the LC value.

JP-A-2000-119710 discloses a method for producing high-purity niobium powder by a two-stage reduction reaction, where niobium pentaoxide is charged into molten magnesium to perform a reduction reaction, the produced NbOx (x=0.5 to 1.5) is taken out and charged into molten magnesium to perform a reduction reaction, and thereby metal niobium is obtained.

The tapping density of a niobium powder such as niobium monoxide used for capacitors is an important factor in the mold working of the niobium powder. The tapping density of conventional niobium powder is 2.5 g/ml or more, specifically about 4 g/ml, and this is insufficient for the molding.

More specifically, if such a niobium monoxide powder is molded and sintered to prepare a sintered body, the niobium monoxide powder poorly flows from the hopper of a molding machine to the metal mold and it is difficult to weigh a constant amount of niobium monoxide powder and flow it into the metal mold. Therefore, there are problems such that the shape of the molded article is not satisfactorily stabilized, the molded article and the sintered body are deficient in the strength, and a capacitor having bad LC is produced at a high frequency. If a special molding apparatus capable of also handling a powder having bad flowability is used, the molding cost excessively increases and this is not practical.

As such, conventionally known niobium monoxide powder for capacitors has a problem in that the powder cannot be fully adapted to continuous molding and the productivity of capacitor is low.

### DISCLOSURE OF THE INVENTION

As a result of extensive investigations, the present inventors have found that when a niobium monoxide sintered body having a specific pore distribution, preferably a niobium monoxide sintered body having a plurality of pore diameter peak tops in the pore distribution is used for the capacitor electrode, a high capacitance appearance ratio can be obtained and a capacitor having small leakage current and good moisture resistance can be produced. The present inventors also have found that a niobium monoxide powder preferably having a tapping density of 0.5 to 2.5 g/ml, more preferably having an average particle size of 10 to 1,000 μm exhibits good flowability, enables continuous molding and is preferred as the material for the above-described sintered body and when this niobium monoxide powder is used, a capacitor having small leakage current can be stably produced.

Furthermore, the present inventors have found that when a niobium monoxide sintered body prepared using a niobium monoxide powder having a wide hole distribution and a plurality of pore diameter peak tops with all of the pore diameter peak tops being 0.5 μm or more is used for the capacitor electrode, a high capacitance appearance ratio and at the same time, a low ESR can be attained.

More specifically, the present invention relates to the following niobium monoxide powder, niobium monoxide sintered body, capacitor using the sintered body, and production methods of these.

[1] A niobium monoxide powder for capacitors, being represented by the formula: NbOx (x=0.8 to 1.2) and having a tapping density of 0.5 to 2.5 g/ml.

[2] The niobium monoxide powder as described in [1] above, which further comprises at least one element selected from the group consisting of magnesium, calcium, strontium, barium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, tantalum, molybdenum, tungsten, manganese, rhenium, ruthenium, osmium, rhodium, iridium, palladium, platinum, silver, gold, zinc, cadmium, mercury, boron, aluminum, gallium, indium, thallium, carbon, silicon, germanium, tin, lead, nitrogen, phosphorus, arsenic, antimony, bismuth, sulfur, selenium and tellurium.

[3] The niobium monoxide powder as described in [1] or [2] above, wherein the other element forms a composite oxide with niobium.

[4] The niobium monoxide powder as described in [2] or [3] above, wherein the content of the other element is from 50 to 200,000 ppm.

[5] The niobium monoxide powder as described in any one of [1] to [4] above, wherein the average particle size is from 10 to 1,000 μm.

[6] The niobium monoxide powder as described in any one of [1] to [5] above, wherein the angle of repose is from 10 to 60°.

[7] The niobium monoxide powder as described in any one of [1] to [6] above, wherein the BET specific surface area is from 0.5 to 40 m²/g.

[8] The niobium monoxide powder as described in any one of [1] to [7] above, which has a pore distribution having a pore diameter peak top in the range from 0.01 to 500 μm.

[9] The niobium monoxide powder as described in [8] above, wherein the pore distribution has a plurality of pore diameter peak tops.

[10] The niobium monoxide powder as described in [8] or [9] above, wherein all of the pore diameter peak tops are in the range from 0.5 to 100 μm.

[11] A sintered body using the niobium monoxide powder described in any one of [1] to [10] above.

[12] The sintered body as described in [11] above, which has a pore distribution having a pore diameter peak top in the range from 0.01 to 500 μm.

[13] A niobium monoxide sintered body for capacitor electrode, wherein the pore distribution of the niobium monoxide sintered body has a plurality of pore diameter peak tops.

[14] The niobium monoxide sintered body as described in any one of [11] to [13] above, wherein the pore distribution has two pore diameter peak tops.

[15] The niobium monoxide sintered body as described in [13] or [14] above, wherein among the plurality of pore diameter peak tops, the peak tops of two peaks having a highest relative intensity are present in the range from 0.2 to 0.7 μm and in the range from 0.7 to 3 μm, respectively.

[16] The niobium monoxide sintered body as described in [13] above, wherein among the plurality of pore diameter peak tops, the peak top of the peak having a highest relative intensity is present in the larger diameter side than the peak top of the peak having a next highest relative intensity.

[17] The niobium monoxide sintered body as described in any one of [11] to [16] above, wherein the sintered body has a volume of 10 mm³ or more including the volume of pore void.

[18] The niobium monoxide sintered body as described in any one of [11] to [17] above, wherein the sintered body has a specific surface area of 0.2 to 7 m²/g.

[19] The niobium monoxide sintered body as described in [11] to [18] above, wherein a part of the sintered body is nitrided.

[20] The niobium monoxide sintered body as described in any one of [11] to [19] above, wherein the sintered body is a sintered body obtained from a niobium monoxide compact of giving a sintered body having a CV value of 40,000 to 200,000 μFV/g when sintered at 1,400° C.

[21] A capacitor comprising the niobium monoxide sintered body described in any one of [11] to [20] above as one part electrode, a counter electrode and a dielectric material interposed therebetween.

[22] The capacitor as described in [21] above, wherein the dielectric material mainly comprises niobium pentaoxide.

[23] The capacitor as described in [21] above, wherein the counter electrode is at least one material selected from the group consisting of an electrolytic solution, an organic semiconductor and an inorganic semiconductor.

[24] The capacitor as described in [23] above, wherein the counter electrode is an organic semiconductor and the organic semiconductor is at least one material selected from the group consisting of an organic semiconductor comprising a benzopyrroline tetramer and chloranile, an organic semiconductor mainly comprising tetrathiotetracene, an organic semiconductor mainly comprising tetracyanoquinodimethane, and an electrically conducting polymer.

[25] The capacitor as described in [24] above, wherein the electrically conducting polymer is at least one member selected from the group consisting of polypyrrole, polythiophene, polyaniline and substitution derivatives thereof.

[26] The capacitor as described in [24] above, wherein the electrically conducting polymer is an electrically conducting polymer obtained by doping a dopant into a polymer containing a repeating unit represented by the following formula (1) or (2):

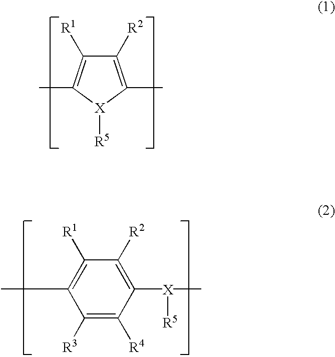

(wherein R¹ to R⁴ each independently represents a monovalent group selected from the group consisting of a hydrogen atom, a linear or branched, saturated or unsaturated alkyl, alkoxy or alkylester group having from 1 to 10 carbon atoms, a halogen atom, a nitro group, a cyano group, a primary, secondary or tertiary amino group, a CF₃ group, a phenyl group and a substituted phenyl group; each of the pairs R¹ and R², and R³ and R⁴ may combine at an arbitrary position to form a divalent chain for forming at least one 3-, 4-, 5-, 6- or 7-membered saturated or unsaturated hydrocarbon cyclic structure together with the carbon atoms substituted by R¹ and R² or by R³ and R⁴; the cyclic combined chain may contain a bond of carbonyl, ether, ester, amide, sulfide, sulfinyl, sulfonyl or imino at an arbitrary position; X represents an oxygen atom, a sulfur atom or a nitrogen atom; R⁵ is present only when X is a nitrogen atom, and independently represents a hydrogen atom or a linear or branched, saturated or unsaturated alkyl group having from 1 to 10 carbon atoms).

[27] The capacitor as described in [26] above, wherein the electrically conducting polymer is an electrically conducting polymer containing a repeating unit represented by the following formula (3):

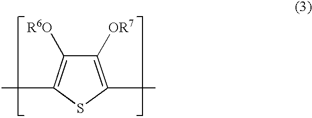

(wherein R⁶ and R⁷ each independently represents a hydrogen atom, a linear or branched, saturated or unsaturated alkyl group having from 1 to 6 carbon atoms, or a substituent for forming at least one 5-, 6- or 7-membered saturated hydrocarbon cyclic structure containing two oxygen elements resulting from the alkyl groups combining with each other at an arbitrary position; and the cyclic structure includes a structure having a vinylene bond which may be substituted, and a phenylene structure which may be substituted).

[28] The capacitor as described in [24] above, wherein the electrically conducting polymer is an electrically conducting polymer obtained by doping a dopant into poly(3,4-ethylenedioxythiophene).

[29] The capacitor as described in [21] above, wherein the counter electrode is formed of a material at least partially having a layer structure.

[30] The capacitor as described in [21] above, wherein the counter electrode is a material containing an organic sulfonate anion as a dopant.

[31] A method for producing a niobium monoxide powder, comprising activation-treating (also called “pore formation treatment”) niobium monoxide or a niobium monoxide compound to produce the niobium monoxide powder described in any one of [1] to [10] above.

[32] The method for producing a niobium monoxide powder as described in [31] above, wherein the activation treatment of niobium monoxide or niobium monoxide compound is performed in at least one step selected from the group consisting of a sintering step and a cracking step.

[33] The method for producing a niobium monoxide powder as described in [31] or [32] above, wherein the activation treatment of niobium monoxide or niobium monoxide compound is performed using a mixture of niobium monoxide or a niobium monoxide compound and an activator.

[34] The method for producing a niobium monoxide powder as described in any one of [31] to [33] above, wherein the average particle size of the niobium monoxide or niobium monoxide compound subjected to the activation treatment is from 0.01 to 10 μm.

[35] The method for producing a niobium monoxide powder as described in any one of [31] to [34] above, wherein the niobium monoxide or niobium monoxide compound contains from 50 to 200,000 ppm of at least one element selected from the group consisting of magnesium, calcium, strontium, barium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, tantalum, molybdenum, tungsten, manganese, rhenium, ruthenium, osmium, rhodium, iridium, palladium, platinum, silver, gold, zinc, cadmium, mercury, boron, aluminum, gallium, indium, thallium, carbon, silicon, germanium, tin, lead, nitrogen, phosphorus, arsenic, antimony, bismuth, sulfur, selenium and tellurium.

[36] The method for producing a niobium monoxide powder as described in [35] above, wherein the other element contained in the niobium monoxide or niobium monoxide compound forms a composite oxide with niobium.

[37] The method for producing a niobium monoxide powder as described in [33] above, wherein the mixture containing niobium monoxide or a niobium monoxide compound and an activator is obtained by mixing these using a solvent.

[38] The method for producing a niobium monoxide powder as described in [37] above, wherein the solvent is at least one solvent selected from the group consisting of water, alcohols, ethers, cellosolves, ketones, aliphatic hydrocarbons, aromatic hydrocarbons and halogenated hydrocarbons.

[39] The method for producing a niobium monoxide powder as described in [33] above, wherein the activator is used in an amount of 1 to 40 mass % based on the total amount of the niobium monoxide or niobium monoxide compound.

[40] The method for producing a niobium monoxide powder as described in [33] or [39] above, wherein the average particle size of the activator is from 0.01 to 500 μm.

[41] The method for producing a niobium monoxide powder as described in any one of [33], [37], [39] and [40] above, wherein the activator has a plurality of particle size peak tops.

[42] The method for producing a niobium monoxide powder as described in any one of [33], [37] and [39] to [41] above, wherein the activator is a substance which is removed as a gas at 2,000° C. or less.

[43] The method for producing a niobium monoxide powder as described in [42] above, wherein the activator is at least one member selected from the group consisting of naphthalene, anthracene, quinone, camphor, polyacrylic acid, polyacrylic acid ester, polyacrylamide, polymethacrylic acid, polymethacrylic acid ester, polymethacrylamide, polyvinyl alcohol, NH₄Cl, ZnO, WO₂, SnO₂ and MnO₃.

[44] The method for producing a niobium monoxide powder as described in any one of [33], [37] and [39] to [41] above, wherein the activator is at least one member selected from the group consisting of a water-soluble substance, an organic solvent-soluble substance, an acidic solution-soluble substance, an alkaline solution-soluble substance, a substance of forming a complex and becoming a substance soluble in water, organic solvent, acidic solution or alkaline solution, and a substance of becoming a substance soluble in water, organic solvent, acidic solution or alkaline solution at 2,000° C. or less.

[45] The method for producing a niobium monoxide powder as described in [44] above, wherein the activator is at least one member selected from the group consisting of compounds of a metal with carbonic acid, sulfuric acid, sulfurous acid, halogen, perhalogen acid, hypohalogen acid, nitric acid, nitrous acid, phosphoric acid, acetic acid, oxalic acid or boric acid, metals, metal hydroxides and metal oxides.

[46] The method for producing a niobium monoxide powder as described in [45] above, wherein the activator is at least one member selected from the group consisting of metal carbonates, metal hydrogencarbonates, metal hydroxides and metal oxides.

[47] The method for producing a niobium monoxide powder as described in [46] above, wherein the activator is at least one member selected from the group consisting of metal carbonates, metal hydrogencarbonates, metal hydroxides and metal oxides, and has a melting point higher than the temperature in the sintering step.

[48] The method for producing a niobium monoxide powder as described in [44] above, wherein the activator is at least one member selected from the group consisting of lithium, sodium, potassium, rubidium, cesium, francium, beryllium, magnesium, calcium, strontium, barium, radium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, niobium, tantalum, molybdenum, tungsten, manganese, rhenium, ruthenium, osmium, cobalt, rhodium, iridium, nickel, palladium, platinum, silver, gold, zinc, cadmium, boron, aluminum, gallium, indium, thallium, carbon, silicon, germanium, tin, lead, arsenic, antimony, bismuth, selenium, tellurium, polonium and compounds thereof.

[49] The method for producing a niobium monoxide powder as described in any one of [31] to [33] above, wherein the activation treatment is a treatment of performing the removal of the activator by heating and/or under reduced pressure before or during the sintering step.

[50] The method for producing a niobium monoxide powder as described in any one of [31] to [33] above, wherein the activation treatment is a treatment of removing the activator component by contacting a solvent with the sintered or cracked product after the sintering step or during or after the cracking step.

[51] The method for producing a niobium monoxide powder as described in [50] above, wherein the solvent is at least one member selected from the group consisting of water, an organic solvent, an acidic solution, an alkaline solution and a solution containing a ligand of forming a soluble complex.

[52] The method for producing a niobium monoxide powder as described in [51] above, wherein the acidic solution is a solution of at least one member selected from the group consisting of nitric acid, sulfuric acid, hydrofluoric acid and hydrochloric acid.

[53] The method for producing a niobium monoxide powder as described in [51] above, wherein the alkaline solution contains at least one member selected from the group consisting of an alkali metal hydroxide and ammonia.

[54] The method for producing a niobium monoxide powder as described in [51] above, wherein the ligand is at least one member selected from the group consisting of ammonia, glycine and ethylenediaminetetraacetic acid.

[55] A method for producing a nitrogen-containing niobium monoxide powder, comprising treating the niobium monoxide powder described in any one of [1] to [10] above by at least one method selected from the group consisting of liquid nitridation, ion nitridation and gas nitridation.

[56] A method for producing a carbon-containing niobium monoxide powder, comprising treating the niobium monoxide powder described in any one of [1] to [10] above by at least one method selected from the group consisting of solid phase carbonization and liquid carbonization.

[57] A method for producing a boron-containing niobium monoxide powder, comprising treating the niobium monoxide powder described in any one of [1] to [10] above by at least one method selected from the group consisting of gas boronization and solid phase boronization.

[58] A method for producing a sulfur-containing niobium monoxide powder, comprising treating the niobium monoxide powder described in any one of [1] to [10] by at least one method selected from the group consisting of gas sulfudization, ion sulfudization and solid phase sulfudization.

[59] A niobium monoxide powder obtained by the production method described in any one of [31] to [58] above.

[60] A method for producing a niobium monoxide sintered body, comprising using the niobium monoxide powder described in any one of [1] to [10] and [59] above.

[61] A method for producing a capacitor comprising a niobium monoxide sintered body as one part electrode, a dielectric material formed on the surface of the sintered body, and a counter electrode provided on the dielectric material, wherein the niobium monoxide sintered body is obtained by sintering the niobium monoxide powder described in any one of [1] to [10] and [59] above.

[62] The method for producing a capacitor as described in [61] above, wherein the dielectric material is formed by electrolytic oxidation.

[63] A method for producing a capacitor comprising a niobium monoxide sintered body as one part electrode, a dielectric material formed on the surface of the sintered body, and a counter electrode provided on the dielectric material, wherein the niobium monoxide sintered body is the niobium monoxide sintered body described in any one of [11] to [20] above.

[64] An electronic circuit using the capacitor described in any one of [21] to [30] above.

[65] An electronic instrument using the capacitor described in any one of [21] to [30] above.

### MODE FOR CARRYING OUT THE INVENTION

The capacitor having high capacitance, low equivalent series resistance (ESR), good leakage current characteristics and excellent moisture resistance, the niobium sintered body capable of bringing such properties and giving a high capacitance appearance ratio, the niobium monoxide powder preferred as a material for this sintered body, having good flowability and capable of continuous molding, and the production methods of these are described below.

In the present invention, a niobium monoxide powder for capacitors (sometimes simply referred to as a “niobium monoxide powder”), having a tapping density of 0.5 to 2.5 g/ml is used as the niobium monoxide powder which satisfies the above-described properties of a capacitor and improves the productivity in the production of capacitors.

The niobium monoxide powder for capacitors as used herein means a niobium monoxide powder mainly comprising niobium monoxide represented by the formula: NbOx (wherein x is 0.8 to 1.2), and being usable as a material for the production of a capacitor.

As for the oxide of niobium, three oxides, namely, niobium monoxide, niobium dioxide and niobium pentaoxide, are known.

In the niobium oxide where x is a number from 0 to 1, metal niobium and niobium monoxide are present together. The metal niobium is readily sintered as compared with niobium monoxide and if a large amount of metal niobium is present, the sintered body can hardly have a large specific surface area and the capacitor is liable to have small capacitance.

In the niobium oxide where x is a number from 1 to 2, niobium monoxide and niobium dioxide are present together. The niobium monoxide is electrically conducting but the niobium dioxide is insulating. If a large amount of niobium dioxide is present, this is disadvantageous for the formation of a dielectric material by electrolytic oxidation.

By taking these into account, the range of x is preferably from 0.8 to 1.2, more preferably from 0.9 to 1.1, still more preferably from 0.95 to 1.05.

The niobium monoxide powder may contain, for example, a component of forming a composite oxide with niobium or at least one component other than niobium, such as nitrogen, phosphorus, antimony, sulfur, selenium and tellurium. By containing such a component other than niobium, the sintering property can be varied and the properties as a capacitor can be improved. Examples of the element other than niobium include magnesium, calcium, strontium, barium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, tantalum, molybdenum, tungsten, manganese, rhenium, ruthenium, osmium, rhodium, iridium, palladium, platinum, silver, gold, zinc, cadmium, mercury, boron, aluminum, gallium, indium, thallium, carbon, silicon, germanium, tin, lead, nitrogen, phosphorus, arsenic, antimony, bismuth, sulfur, selenium and tellurium.

For example, the sintered body for capacitors can be obtained as follows by molding and sintering the niobium monoxide powder.

The niobium monoxide powder for capacitors is added to a solution obtained by dissolving a binder which is described later in an organic solvent such as toluene or methanol, and thoroughly mixed using a shaking mixer or a V-type mixer. Thereafter, the organic solvent is distilled off under reduced pressure using a drier such as conical drier to prepare a niobium monoxide mixed powder containing the binder. This mixed powder is charged into the hopper of an automatic molding machine, weighed while flowing the niobium monoxide mixed powder through an inlet tube from the hopper to the metal mold of a molding machine to automatically cause spontaneous falling in the metal mold, and molded together with a lead wire. After removing the binder under reduced pressure, this molded article is sintered at 500 to 2,000° C. to manufacture a niobium monoxide sintered body.

Then, the niobium monoxide sintered body is subjected to electrochemical forming, for example, at a temperature of 30 to 90° C. for from 1 to 30 hours in an electrolytic solution having a concentration of about 0.1 mass %, such as phosphoric acid or adipic acid, by elevating the voltage to 20 to 60 V to form a dielectric layer mainly comprising niobium pentaoxide. On this dielectric layer, a solid electrolyte layer such as lead dioxide or electrically conducting polymer is formed and further thereon, a graphite layer and a silver paste layer are formed. Subsequently, a cathode terminal is connected thereon by soldering or the like and the whole is sealed with resin to manufacture a solid electrolytic capacitor.

In the case of a mixed powder not having an appropriate flowability or angle of repose, the powder does not smoothly flow at the molding from the hopper to the metal mold and the molding cannot be stably performed. In particular, since the mixed powder is transported from the hopper using a method such as vibration, too large or too small tapping density or average particle size of the mixed powder leads to large dispersion in the mass of molded articles or in the strength or shape of sintered bodies and in some cases, to the generation of chipping or cracking, resulting in bad leakage current. As such, the tapping density, the average particle size, the flowability and the angle of repose of the mixed powder are important factors for producing good sintered body and good capacitor.

These physical properties of the mixed powder scarcely change between before and after the mixing with a binder but are determined by the physical properties of the niobium monoxide powder for capacitors used. Accordingly, important are the tapping density, the average particle size, the flowability and the angle of repose of the niobium monoxide powder used. The flowability and the angle of repose of the niobium monoxide powder are greatly affected by the tapping density or the average particle size and therefore, the tapping density and the average particle size are important factors.

In the present invention, for increasing the productivity and the strength of the sintered body accompanying the improvement of flowability or angle of repose and thereby obtaining an effect of reducing the leakage current, the tapping density is preferably from 0.5 to 2.5 g/ml, more preferably from 0.7 to 1.9 g/ml, still more preferably from 0.7 to 1.6 g/ml. The average particle size of the niobium monoxide powder of the present invention is preferably from 10 to 1,000 μm, more preferably from 50 to 200 μm.

For allowing the niobium monoxide powder to spontaneously fall from the hopper to the metal mold of a molding machine, the angle of repose of the niobium monoxide powder of the present invention is preferably from 10 to 60°, more preferably from 10 to 50°.

The niobium monoxide powder having the above-described physical properties can be produced starting from a mixture (hereinafter referred to as “a starting material mixture”) containing a niobium monoxide powder or a niobium monoxide compound powder (hereinafter these are called “a starting material niobium monoxide powder”) and an activator (also called “pore-forming agent”, hereinafter sometimes referred to as “an additive”) through at least a sintering step and a cracking step in sequence.

The activator is removed from the starting material mixture in either the sintering step or the cracking step during the production of the niobium monoxide powder of the present invention. The removal of the activator may also be performed independently of the sintering step or the cracking step.

For the removal of activator, various methods may be freely employed according to the chemical properties of the activator. One of the methods capable of easily removing the activator may be used or a plurality of these methods may be used in combination.

Examples of the method for removing the activator include a method of evaporating, sublimating or thermally decomposing the activator and removing it as a gas, and a method of removing the activator by dissolving it in a solvent.

In the case of removing the activator as a gas, the removal may be performed in the sintering step, or a step of removing the activator under heating and/or reduced pressure may be provided before the sintering.

In the case of removing the activator by dissolving it in a solvent, a solvent which is described later is contacted with the sintered product or a cracked product thereof after the sintering of the starting material mixture or during or after the cracking, thereby dissolving and removing the activator.

A step of nitriding, boronizing, carbonizing or sulfudizing a part of niobium monoxide powder may be provided at any stage in the process of producing the niobium monoxide powder of the present invention from the starting material mixture.

The method for producing the niobium monoxide powder of the present invention is described in detail below.

The starting material niobium monoxide powder may be at least one powder selected from a niobium monoxide (NbOx: x=0.8 to 1.2), a niobium monoxide containing at least one element selected from the group consisting of magnesium, calcium, strontium, barium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, tantalum, molybdenum, tungsten, manganese, rhenium, ruthenium, osmium, rhodium, iridium, palladium, platinum, silver, gold, zinc, cadmium, mercury, boron, aluminum, gallium, indium, thallium, carbon, silicon, germanium, tin, lead, nitrogen, phosphorus, arsenic, antimony, bismuth, sulfur, selenium and tellurium, and a composite oxide thereof. A part of the powder may further be nitrided, sulfudized, carbonized or boronized.

The average particle size of the starting material niobium monoxide powder for use in the present invention is preferably from 0.01 to 10 μm, more preferably from 0.02 to 5 μm, still more preferably from 0.05 to 2 μm.

From the standpoint of improving the sintering property or the electrical capability of capacitor obtained, the amount of the other element contained is preferably from 50 to 500,000 mass ppm, more preferably from 50 to 200,000 mass ppm.

Examples of the method for obtaining a niobium monoxide used as the starting material niobium monoxide powder include a method of reducing niobium pentaoxide using a metal having a reducing activity, such as calcium or magnesium, a method of reducing niobium dioxide powder by heating it in a hydrogen stream, and a method of mixing niobium metal powder and niobium dioxide powder and heating the mixture in argon.

Examples of the method for obtaining niobium monoxide containing other element, which is used as the starting niobium monoxide powder, include a method of reducing a starting material such as a composite oxide with other element, a mixture of niobium pentaoxide and an oxide of other element, or niobium dioxide and an oxide of other element, by heating it in a hydrogen stream or by using a metal having a reducing activity, such as calcium, magnesium, yttrium, lanthanum, cerium, samarium or misch metal, a method of oxidizing an alloy of niobium and other element by heating it in air, a method of heating a mixture of niobium monoxide powder and other element compound, and a method of reacting niobium monoxide with other element in the state of gas, solid or liquid. The particle size of the obtained powder can be adjusted by pulverizing the powder according to an ordinary method.

For example, in order to obtain a niobium monoxide powder containing boron as the other element, a method of mixing niobium boride powder and niobium monoxide powder and heating the mixture, a method of heating niobium boride powder in air, or a method of heating and reacting gaseous boron and niobium monoxide may be used.

The activator is a substance which can be removed at any step during the production of the niobium monoxide powder of the present invention from the starting material mixture. In the niobium monoxide powder of the present invention, a pore is usually formed in the portion where the activator is removed.

The particle size of the activator affects the pore diameter of the niobium monoxide powder of the present invention, the pore diameter of the niobium monoxide powder affects the pore diameter of the niobium monoxide sintered body, and the pore diameter of the sintered body affects the capacitance of capacitor and the impregnating ability of cathode agent in the production step of a capacitor.

The impregnating ability of the cathode agent greatly affects the preparation of a capacitor having high capacitance and low ESR. The niobium monoxide sintered body is prepared by molding niobium monoxide powder under pressure and therefore, the pore diameter of the sintered body is necessarily smaller than the pore diameter of the niobium monoxide powder. On considering the difficulty in the impregnation of a cathode agent into a sintered body prepared from a powder having a small pore diameter peak, the pore diameter of the niobium monoxide powder is, in terms of an average diameter, preferably 0.5 μm or more, more preferably 1 μm or more.

The average pore diameter is preferably from 0.01 to 500 μm, more preferably from 0.03 to 300 μm, still more preferably from 0.1 to 200 μm. For having a pore diameter in this range, the average particle size of the activator is preferably from 0.01 to 500 μm, more preferably from 0.03 to 300 μm, still more preferably from 0.1 to 200 μm.

The most preferred pore diameter of the niobium monoxide powder is, in terms of an average diameter, from 0.5 to 100 μm and for having such a pore diameter, the average particle size of the activator is most preferably from 0.5 to 100 μm.

The pore diameter may be reduced by using an activator having a small particle size and the pore diameter may be increased by using an activator having a large particle size.

The pore diameter distribution can be adjusted by adjusting the particle size distribution of the activator.

In order to cause no problem in the impregnating ability of a cathode agent and obtain a capacitor having a sufficiently large capacitance, it is preferred to appropriately provide pores small enough to give a desired capacitance and pores large enough to ensure satisfactory impregnation of a cathode agent, in the niobium monoxide sintered body according to the physical properties of the cathode agent.

For adjusting the pore diameter distribution of the niobium monoxide powder or niobium monoxide sintered body, for example, the niobium monoxide powder can be made to have a pore diameter distribution having two or more peak tops by using an activator (powder) having a particle size distribution with two or more peak tops. By sintering this niobium monoxide powder, a niobium monoxide sintered body having two or more peak tops of equal pore diameter in the pore diameter distribution can be obtained. In this case, the pore diameter peak top is preferably present in the range of 0.01 to 500 μm, more preferably from 0.03 to 300 μm, still more preferably from 0.1 to 200 μm, particularly preferably from 0.1 to 30 μm, most preferably from 0.2 to 3 μm.

The niobium monoxide powder of giving such a niobium monoxide sintered body has two or more pore diameter peak tops. These two or more pore diameter peak tops of the niobium monoxide powder all are preferably at 0.5 μm or more. For example, in the case of a niobium monoxide sintered body having two pore diameter peak tops at 0.7 μm and 3 μm, this may be attained by adjusting two pore diameter peak tops of the niobium monoxide powder to about 1.5 μm and about 25 μm. The average particle size of the activator of giving such small pore diameter as about 1.5 μm is about 1.5 μm and the average particle size of the activator of giving a large pore diameter of about 25 μm is about 25 μm. Usually, when a small pore and a large pore are present in the niobium monoxide powder, the large pore is crushed and becomes small at the pressure molding. Accordingly, the large pore diameter peak top is preferably present at 20 μm or more. In the case where three pore diameter peak tops are present, the large pore diameter peak top is also preferably present at 20 μm or more. Pores having a pore diameter of 20 μm or more preferably occupy 30 vol % or more, more preferably 40 vol % or more, of the entire hole volume.

The activator having two or more peak tops in the particle size distribution can be obtained, for example, by mixing two or more activators different in the peak top in the particle size distribution.

Examples of the substance as the activator include a substance which becomes a gas at the sintering temperature or less, and a substance which is soluble in a solvent at least after the sintering.

Examples of the substance which becomes a gas at the sintering temperature or less include a substance which becomes a gas through evaporation, sublimation or thermal decomposition. An inexpensive substance capable of easily becoming a gas even at a low temperature without causing a residue is preferred. Examples of the substance include aromatic compounds such as naphthalene, anthracene and quinone, camphor, NH₄Cl, ZnO, WO₂, SnO₂, MnO₃ and organic polymers.

Examples of the organic polymer include polyacrylic acid, polyacrylic acid ester, polyacrylamide, polymethacrylic acid, polymethacrylic acid ester, polymethacrylamide and polyvinyl alcohol.

The substance which is soluble at least after the sintering is a substance such that the residue of the activator or a thermally decomposed product thereof is soluble in a solvent. A substance capable of easily dissolving in a solvent which is described later, after the sintering or during or after the cracking is particularly preferred. Such a substance can be selected from many substances according to the combination with the solvent.

Examples of the substance include compounds of a metal with carbonic acid, sulfuric acid, sulfurous acid, halogen, perhalogen acid, hypohalogen acid, nitric acid, nitrous acid, phosphoric acid, acetic acid, oxalic acid or boric acid, metal oxides, metal hydroxides and metals.

Among these, preferred are compounds having a large solubility in a solvent such as acid, alkali or ammonium salt solution which are described later. Examples thereof include compounds containing at least one member selected from the group consisting of lithium, sodium, potassium, rubidium, cesium, francium, beryllium, magnesium, calcium, strontium, barium, radium, scandium, yttrium, cerium, neodymium, erbium, titanium, zirconium, hafnium, vanadium, niobium, tantalum, molybdenum, tungsten, manganese, rhenium, ruthenium, osmium, cobalt, rhodium, iridium, nickel, palladium, platinum, silver, gold, zinc, cadmium, aluminum, gallium, indium, thallium, germanium, tin, lead, antimony, bismuth, selenium, tellurium, polonium, boron, silicon and arsenic. Among these, preferred are metal salts and more preferred are, for example, barium oxide, manganese(II) nitrate and calcium carbonate.

These activators may be used individually or in combination of two or more thereof.

From the standpoint of efficiently forming specific pores, a substance which is present as a solid at the sintering temperature is preferred, because when the activator is present as a solid at the sintering temperature, niobium monoxide primary powder is blocked from excessive aggregation and niobium monoxides are allowed to fuse each other only at the contact point therebetween. If the activator is present as a liquid or a gas at the sintering temperature, the blocking effect is small and pores smaller than the desired pore may be formed. Accordingly, when a high melting point substance such as barium oxide, calcium carbonate, aluminum oxide or magnesium oxide is used as the activator, the pore size is more stabilized than in the case where a low melting point substance such as zinc metal, tin metal or antimony oxide is used as the activator.

If the activator is added in a small amount, the tapping density and the angle of repose become large, whereas if added in a large amount, the tapping density becomes small and closed pores increase at the stage of sintering. For not causing the problem of closed pores at the sintering stage and for obtaining a repose angle of 60° or less and a tapping density of 0.5 to 2.5 g/ml, the amount of the activator added is generally from 1 to 40 mass % or less (unless otherwise indicated, mass % is hereinafter simply referred to as %), preferably from 5 to 25%, more preferably from 10 to 20%, based on the starting material niobium monoxide, though this varies depending on the average particle size of the activator.

The starting material mixture may be obtained by mixing the activator and the niobium monoxide starting material each in the powder form using no solvent or by mixing the activator and the niobium starting material using an appropriate solvent and drying the mixture.

Examples of the solvent which can be used include water, alcohols, ethers, cellosolves, ketones, aliphatic hydrocarbons, aromatic hydrocarbons and halogenated hydrocarbons.

The mixing may be performed using a mixer. As for the mixer, a normal apparatus such as shaking mixer, V-type mixer and Nauter mixer may be used without any problem. The temperature at the mixing is limited by the boiling point and freezing point of the solvent but is generally from −50° C. to 120° C., preferably from −50° C. to 50° C., more preferably from −10° C. to 30° C. The time spent for the mixing is not particularly limited insofar as it is 10 minutes or more, however, generally, the mixing is preferably performed for 1 to 6 hours.

In the case of using a solvent, the mixture obtained is dried at less than 80° C., preferably less than 50° C., using a conical drier or a compartment drier.

In the case where the activator becomes a gas at the sintering temperature or less, the activator may be removed at the sintering but a step of forming the activator into a gas and removing it before the sintering may be independently provided by setting the conditions such as temperature, pressure and time period to those of facilitating the removal according to the chemical properties of the activator. In this case, the activator is distilled off, for example, at 100 to 800° C. under reduced pressure within a few hours.

The sintering step is performed at 500 to 2,000° C., preferably from 800 to 1,500° C., more preferably from 1,000 to 1,400° C., under reduced pressure or in a reducing atmosphere such as argon. After the completion of sintering, the sintered product is preferably cooled until the niobium monoxide temperature (sometimes simply referred to as a “product temperature”) becomes 30° C. or less, an inert gas such as nitrogen or argon containing from 0.01 to 10 vol %, preferably from 0.1 to 1 vol %, of oxygen is gradually added such that the product temperature does not exceed 30° C., and the sintered product is left standing for 8 hours or more and then taken out to obtain a sintered lump.

In the cracking step, the sintered lump is cracked to an appropriate particle size using a cracking machine such as roll granulator.

In the case where the activator is soluble in a solvent at least after the sintering step, an appropriate solvent is contacted with the sintered lump or the cracked powder after the sintering, before, during or after the cracking or at a plurality of these steps and thereby, the activator component is dissolved and removed. In view of easiness of removal, the activator component is preferably dissolved and removed from the cracked powder after cracking.

The solvent used here is a solvent in which the activator to be dissolved has a sufficiently high solubility. A solvent which is inexpensive and hardly remains is preferred. For example, in the case of a water-soluble activator, water may be used; in the case of an organic solvent-soluble activator, an organic solvent such as methyl isobutyl ketone, ethanol or dimethyl sulfoxide (DMSO) may be used; in the case of an acid-soluble activator, an acid solution such as nitric acid, sulfuric acid, phosphoric acid, boric acid, carbonic acid, hydrofluoric acid, hydrochloric acid, hydrobromic acid, hydroiodic acid or organic acid may be used; in the case of an alkali-soluble activator, an alkali solution such as hydroxide of alkali metal, hydroxide of alkaline earth metal or ammonia may be used; and in the case of an activator which forms a soluble complex, a solution of an amine such as ammonia or ethylenediamine, an amino acid such as glycine, a polyphosphoric acid such as sodium tripolyphosphate, a crown ether, a thiosulfate such as sodium thiosulfate, or a chelating agent such as ethylenediaminetetraacetic acid, which becomes a ligand of the complex, may be used.

Also, a solution of ammonium salt such as ammonium chloride, ammonium nitrate and ammonium sulfate, a cation exchange resin, and an anion exchange rein may be suitably used.

The temperature at the time of dissolving and removing the activator is preferably lower. The activator is preferably dissolved and removed at 50° C. or less, more preferably from −10 to 40° C., still more preferably from 0 to 30° C. A method of generating less heat at the dissolution removal is preferably selected. For example, in the case of using a metal oxide or a metal as the activator, the method of dissolving and removing the activator with an acid is disadvantageous because neutralization heat is generated and the temperature becomes excessively high in some cases. Accordingly, a method of difficultly generating heat, for example, a method of dissolving the activator in water or an organic solvent, a method of forming a soluble complex using an aqueous ammonium nitrate solution or ethylenediaminetetraacetic acid, or a method of dissolving the activator in a solution containing ion exchange resin may be selected.

Specific examples of the combination of an activator and a solvent include barium oxide and water, calcium oxalate and hydrochloric acid, aluminum oxide and aqueous sodium hydroxide solution, hafnium oxide and methyl isobutyl ketone, and magnesium carbonate and aqueous tetrasodium ethylenediaminetetraacetate solution.

After dissolving and removing the activator, the residue is thoroughly washed and dried. For example, in the case where barium oxide is removed with water, the residue is thoroughly washed using ion exchange water until the electric conductivity of the washing solution is reduced to 5 μS/cm or less. Subsequently, the product is dried at a product temperature of 50° C. or less under reduced pressure. Here, the amount of the remaining activator or solvent component is usually 100 ppm or less, though this varies depending on the washing conditions.

In order to more improve the sintering property, the thus-obtained niobium monoxide powder, the sintered lump or the niobium monoxide starting material powder may be further subjected to a treatment for nitriding, boronizing, carbonizing or sulfudizing a part of the niobium monoxide powder, or to a plurality of these treatments.

The niobium monoxide powder of the present invention may contain the obtained nitride of niobium monoxide, boride of niobium monoxide, carbide of niobium monoxide, sulfide of niobium monoxide or a plurality of these species. The total content of respective elements of nitrogen, boron, carbon and sulfur varies depending on the shape of the niobium monoxide powder, however, is from 0 to 200,000 ppm, preferably 50 to 100,000 ppm, more preferably 200 to 20,000 ppm. If the total content exceeds 200,000 ppm, the capacitor produced is deteriorated in the capacitance characteristics and not suitable as a capacitor.

The nitridation of the niobium monoxide powder can be performed by any one of liquid nitridation, ion nitridation and gas nitridation or by a combination thereof. Among these, gas nitridation by a nitrogen gas atmosphere is preferred because the apparatus therefor is simple and the operation is easy. For example, the gas nitridation by a nitrogen gas atmosphere can be attained by allowing the above-described niobium monoxide powder to stand in a nitrogen atmosphere. With a nitridation atmosphere temperature of 2,000° C. or less and a standing time of 100 hours or less, a niobium monoxide powder having an objective nitrided amount can be obtained. The treatment time can be shortened by performing the treatment at a higher temperature.

The boronization of the niobium monoxide powder may be either gas boronization or solid phase boronization. For example, the niobium monoxide powder may be boronized by allowing it to stand together with a boron source such as boron pellet or boron halide (e.g., trifluoroboron), at 2,000° C. or less for from 1 minute to 100 hours under reduced pressure.

The carbonization of the niobium monoxide powder may be any one of gas carbonization, solid phase carbonization and liquid carbonization. For example, the niobium monoxide powder may be carbonized by allowing it to stand together with a carbon source such as carbon material or organic material having carbon (e.g., methane), at 2,000° C. or less for from 1 minute to 100 hours under reduced pressure.

The sulfudization of the niobium monoxide powder may be any one of gas sulfudization, ion sulfudization and solid phase sulfudization. For example, the gas sulfudization by a sulfur gas atmosphere can be attained by allowing the niobium monoxide powder to stand in a sulfur atmosphere. With a sulfudization atmosphere temperature of 2,000° C. or less and a standing time of 100 hours or less, a niobium monoxide powder having an objective sulfudized amount can be obtained. The treatment time can be shortened by performing the treatment at a higher temperature.

The BET specific surface area of the thus-obtained niobium monoxide powder of the present invention is usually from 0.5 to 40 m²/g, preferably from 0.7 to 10 m²/g, more preferably from 0.9 to 2 m²/g.

The niobium monoxide powder of the present invention may be a mixture of niobium monoxide powders different in the tapping density, the particle size, the angle of repose, the BET specific surface area, the pore diameter distribution and the treatment by nitridation, boronization, carbonization or sulfudization.

The sintered body of the present invention, which can be used as an electrode for capacitors, is preferably produced, for example, by sintering the above-described niobium monoxide powder of the present invention. For example, the sintered body can be obtained by press-molding the niobium monoxide powder into a predetermined shape and then heating it at from 500 to 2,000° C., preferably from 800 to 1,500° C., more preferably from 1,000 to 1,400° C., for 1 minute to 10 hours under a pressure of 10⁻⁵ to 10² Pa.

The pore size distribution of the sintered body obtained from the niobium monoxide powder of the present invention usually has a pore diameter peak top in the range from 0.01 to 500 μm.

By adjusting the applied pressure at the molding to a specific pressure value, the sintered body can be rendered to have a larger number of pore diameter peak tops than the number of pore diameter peak tops of the niobium monoxide powder. This applied pressure value varies depending on the physical properties of niobium monoxide powder, the shape of molded article and the press-molding conditions such as molding machine but is in the range from a pressure capable of press-molding to a pressure where pores of the sintered body are not closed. The preferred pressure value can be determined by a preliminary experiment according to the physical properties of the niobium monoxide powder to be molded so as to have a plurality of pore size peak tops. The applied pressure value can be controlled, for example, by controlling the load of the molding machine applied on the molded article.

The pore size distribution of the sintered body preferably has at least two pore size peak tops so as to contain pores small enough to obtain a desired capacitance and pores large enough to ensure satisfactory impregnation of a cathode agent according to the physical properties of the cathode agent. From such a sintered body having a plurality of peak tops in the pore diameter distribution, a capacitor having excellent impregnating ability of a counter electrode and a high capacitance appearance ratio can be obtained.

When among a plurality of pore diameter peak tops, the peak tops of two peaks having a highest relative intensity are present in the range from 0.2 to 0.7 μm and in the range from 0.7 to 3 μm, respectively, preferably from 0.2 to 0.7 μm and from 0.9 to 3 μm, respectively, the capacitor produced from this sintered body can have good moisture resistance. Among a plurality of the pore diameter peak tops, the peak top of the peak having a highest relative intensity is preferably present in the larger diameter side than the peak top of the peak having a next highest relative intensity, because the capacitor can have more excellent moisture resistance.

The specific surface area of the thus-produced sintered body is generally from 0.2 to 7 m²/g.

Usually, as the shape of the sintered body is larger, the impregnation of a counter electrode is more difficult. For example, in the case where the sintered body has a size of 10 mm³ or more, the sintered body having a plurality of peak tops in the pore diameter distribution of the present invention can be particularly effectively used.

The sintered body of the present invention may be partially nitrided. As for the nitridation method, the method and reaction conditions described above with respect to the niobium monoxide powder can be employed. It is also possible to previously nitride a part of the niobium monoxide powder for use in the manufacture of a sintered body and further nitride a part of the sintered body produced from this powder.

Such a sintered body usually contains from 0.8 to 1.2 molar times of oxygen element to the niobium element. This includes oxygen contained in the niobium monoxide powder before the sintering and oxygen added by the natural oxidation at the sintering. In the sintered body of the present invention, the content of elements except for niobium monoxide, added element, oxygen and nitrogen is usually 400 mass ppm or less.

As one example, when the sintered body of the present invention is sintered at 1,400° C., the CV value (the product of the electrochemical forming voltage in the electro-chemical forming at 80° C. for 120 minutes in an aqueous 0.1 mass % phosphoric acid solution and the capacitance at 120 Hz) is from 40,000 to 200,000 μFV/g.

The production of a capacitor device is described below.

For example, a lead wire comprising a valve-acting metal such as niobium or tantalum and having appropriate shape and length is prepared and this lead wire is integrally molded at the press-molding of the niobium monoxide powder such that a part of the lead wire is inserted into the inside of the molded article, whereby the lead wire can work out to a leading line of the sintered body. Or, the niobium monoxide powder is molded and sintered without using a lead wire and then, a lead wire separately prepared is connected thereto by welding or the like.

Using this sintered body as one part electrode, a capacitor can be produced by interposing a dielectric material between this one part electrode and a counter electrode. For example, a capacitor is manufactured by using a niobium monoxide sintered body as one electrode, forming a dielectric material on the surface of the sintered body (including the inner surface of pore) and providing a counter electrode on the dielectric material.

The dielectric material used here for the capacitor is preferably a dielectric material mainly comprising niobium oxide, more preferably a dielectric material mainly comprising niobium pentaoxide. The dielectric material mainly comprising niobium pentaoxide can be obtained, for example, by electrolytically oxidizing the niobium monoxide sintered body as one part electrode. For electrolytically oxidizing the niobium monoxide electrode in an electrolytic solution, an aqueous protonic acid solution is generally used, such as aqueous 0.1% phosphoric acid solution, aqueous sulfuric acid solution, aqueous 1% acetic acid solution or aqueous adipic acid solution. In the case of obtaining a niobium oxide dielectric material by electrochemically forming the niobium monoxide electrode in an electrolytic solution as such, the capacitor of the present invention is an electrolytic capacitor and the niobium monoxide electrode serves as an anode.

In the capacitor of the present invention, the counter electrode to the niobium monoxide sintered body is not particularly limited and, for example, at least one material (compound) selected from electrolytic solutions, organic semiconductors and inorganic semiconductors known in the art of aluminum electrolytic capacitor, may be used.

Specific examples of the electrolytic solution include a dimethylformamide-ethylene glycol mixed solution having dissolved therein 5 mass % of an isobutyltripropylammonium borotetrafluoride electrolyte, and a propylene carbonate-ethylene glycol mixed solution having dissolved therein 7 mass % of tetraethylammonium borotetrafluoride.

Specific examples of the organic semiconductor include an organic semiconductor comprising benzenepyrroline tetramer and chloranile, an organic semiconductor mainly comprising tetrathiotetracene, an organic semiconductor mainly comprising tetracyanoquinodimethane, and an electrically conducting polymer containing a repeating unit represented by the following formula (1) or (2):

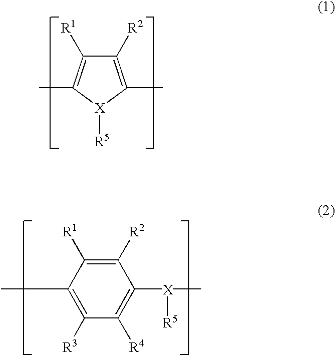

wherein R¹ to R⁴ each independently represents a monovalent group selected from the group consisting of a hydrogen atom, a linear or branched, saturated or unsaturated alkyl, alkoxy or alkylester group having from 1 to 10 carbon atoms, a halogen atom, a nitro group, a cyano group, a primary, secondary or tertiary amino group, a CF₃ group, a phenyl group and a substituted phenyl group; each of the pairs R¹ and R², and R³ and R⁴ may combine at an arbitrary position to form a divalent chain for forming at least one 3-, 4-, 5-, 6- or 7-membered saturated or unsaturated hydrocarbon cyclic structure together with the carbon atoms substituted by R¹ and R² or by R³ and R⁴; the cyclic combined chain may contain a bond of carbonyl, ether, ester, amide, sulfide, sulfinyl, sulfonyl or imino at an arbitrary position; X represents an oxygen atom, a sulfur atom or a nitrogen atom; R⁵ is present only when X is a nitrogen atom, and independently represents a hydrogen atom or a linear or branched, saturated or unsaturated alkyl group having from 1 to 10 carbon atoms.

In the present invention, R¹ to R⁴ in formula (1) or (2) each independently preferably represents a hydrogen atom or a linear or branched, saturated or unsaturated alkyl or alkoxy group having from 1 to 6 carbon atoms, and each of the pairs R¹ and R², and R³ and R⁴ may combine to form a ring.

In the present invention, the electrically conducting polymer containing a repeating unit represented by formula (1) is preferably an electrically conducting polymer containing a structure unit represented by the following formula (3) as a repeating unit:

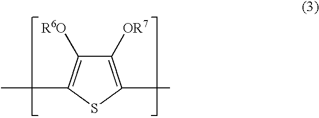

wherein R⁶ and R⁷ each independently represents a hydrogen atom, a linear or branched, saturated or unsaturated alkyl group having from 1 to 6 carbon atoms, or a substituent for forming at least one 5-, 6- or 7-membered saturated hydrocarbon cyclic structure containing two oxygen elements resulting from the alkyl groups combining with each other at an arbitrary position; and the cyclic structure includes a structure having a vinylene bond which may be substituted, and a phenylene structure which may be substituted.

The electrically conducting polymer containing such a chemical structure is doped with a dopant and for the dopant, known dopants can be used without limitation.

Specific examples of the inorganic semiconductor include an inorganic semiconductor mainly comprising lead dioxide or manganese dioxide, and an inorganic semiconductor comprising triiron tetraoxide. These semiconductors may be used individually or in combination of two or more thereof.

Examples of the polymer containing a repeating unit represented by formula (1) or (2) include polyaniline, polyoxyphenylene, polyphenylene sulfide, polythiophene, polyfuran, polypyrrole, polymethylpyrrole, and substitution derivatives and copolymers thereof. Among these, preferred are polypyrrole, polythiophene and substitution derivatives thereof (e.g., poly(3,4-ethylenedioxythiophene)).

When the organic or inorganic semiconductor used has an electrical conductivity of 10⁻² to 10³ S/cm, the capacitor produced can have a smaller impedance value and can be more increased in the capacitance at a high frequency.

The electrically conducting polymer layer is produced, for example, by a method of polymerizing a polymerizable compound such as aniline, thiophene, furan, pyrrole, methylpyrrole or a substitution derivative thereof under the action of an oxidizing agent capable of satisfactorily undergoing an oxidation reaction of dehydrogenative two-electron oxidation. Examples of the polymerization reaction from the polymerizable compound (monomer) include vapor phase polymerization and solution polymerization. The electrically conducting polymer layer is formed on the surface of the niobium sintered body having thereon a dielectric material. In the case where the electrically conducting polymer is an organic solvent-soluble polymer capable of solution coating, a method of coating the polymer on the surface of the sintered body to form an electrically conducting polymer layer is used.

One preferred example of the production method using the solution polymerization is a method of dipping the niobium monoxide sintered body having formed thereon a dielectric layer in a solution containing an oxidizing agent (Solution 1) and subsequently dipping the sintered body in a solution containing a monomer and a dopant (Solution 2), thereby performing the polymerization to form an electrically conducting polymer layer on the surface of the sintered body. Also, the sintered body may be dipped in Solution 1 after it is dipped in Solution 2. Solution 2 used in the above-described method may be a monomer solution not containing a dopant. In the case of using a dopant, the dopant may be allowed to be present together in the solution containing an oxidizing agent.

The operation of performing these polymerization steps is repeated once or more, preferably from 3 to 20 times, per the niobium monoxide sintered body having thereon a dielectric material, whereby a dense and stratified electrically conducting polymer layer can be easily formed.

In the production method of a capacitor of the present invention, any oxidizing agent may be used insofar as it does not adversely affect the capacitor performance and the reductant of the oxidizing agent can work out to a dopant and elevate the electrically conductivity of the electrically conducting polymer. An industrially inexpensive compound easy to handle at the production is preferred.

Specific examples of the oxidizing agent include Fe(III)-base compounds such as FeCl₃, FeClO₄ and Fe (organic acid anion) salt; anhydrous aluminum chloride/cupurous chloride; alkali metal persulfates; ammonium persulfates; peroxides; manganeses such as potassium permanganate; quinines such as 2,3-dichloro-5,6-dicyano-1,4-benzoquinone (DDQ), tetrachloro-1,4-benzoquinone and tetracyano-1,4-benzoquinone; halogens such as iodine and bromine; peracid; sulfonic acid such as sulfuric acid, fuming sulfuric acid, sulfur trioxide, chlorosulfuric acid, fluorosulfuric acid and amidosulfuric acid; ozone; and a mixture of a plurality of these oxidizing agents.

Examples of the fundamental compound of the organic acid anion for forming the above-described Fe (organic acid anion) salt include organic sulfonic acid, organic carboxylic acid, organic phosphoric acid and organic boric acid. Specific examples of the organic sulfonic acid include benzenesulfonic acid, p-toluenesulfonic acid, methanesulfonic acid, ethanesulfonic acid, α-sulfonaphthalene, β-sulfonaphthalene, naphthalenedisulfonic acid and alkylnaphthalenesulfonic acid (examples of the alkyl group include butyl, triisopropyl and di-tert-butyl).

Specific examples of the organic carboxylic acid include acetic acid, propionic acid, benzoic acid and oxalic acid. Furthermore, polymer electrolyte anions such as polyacrylic acid, polymethacrylic acid, polystyrenesulfonic acid, polyvinylsulfonic acid, poly-α-methylsulfonic acid polyvinylsulfate, polyethylenesulfonic acid and polyphosphoric acid may also be used in the present invention. These organic sulfuric acids and organic carboxylic acids are mere examples and the present invention is not limited thereto. Examples of the counter cation to the above-described anion include alkali metal ions such as H⁺, Na⁺ and K⁺, and ammonium ions substituted by a hydrogen atom, a tetramethyl group, a tetraethyl group, a tetrabutyl group or a tetraphenyl group, however, the present invention is not limited thereto. Among these oxidizing agents, preferred are oxidizing agents containing a trivalent Fe-base compound, cuprous chloride, an alkali persulfate, an ammonium persulfate or a quinone.

For the anion having a dopant ability which is allowed to be present together, if desired, in the production of a polymer composition for the electrically conducting polymer (anion other than the reductant anion of the oxidizing agent), an electrolyte anion having as a counter anion an oxidizing agent anion (a reductant of oxidizing agent) produced from the above-described oxidizing agent, or other electrolyte anion may be used. Specific examples thereof include protonic acid anions including halide anion of Group 5B elements, such as PF₆⁻, SbF₆⁻ and AsF₆⁻; halide anion of Group 3B elements, such as BF₄⁻; halogen anion such as I⁻(I₃⁻), Br⁻ and Cl⁻; perhalogenate anion such as ClO₄⁻; Lewis acid anion such as AlCl₄⁻, FeCl₄⁻ and SnCl₅⁻; inorganic acid anion such as NO₃⁻ and SO₄²⁻; sulfonate anion such as p-toluenesulfonic acid, naphthalenesulfonic acid and alkyl-substituted naphthalenesulfonic acid having from 1 to 5 carbon atoms (hereinafter simply referred to as “C1-5”); organic sulfonate anion such as CF₃SO₃⁻ and CH₃SO₃⁻; and carboxylate anion such as CH₃COO⁻ and C₆H₅COO⁻.

Other examples include polymer electrolyte anions such as polyacrylic acid, polymethacrylic acid, polystyrenesulfonic acid, polyvinylsulfonic acid, polyvinylsulfonic acid, poly-α-methylsulfonic acid, polyethylenesulfonic acid and polyphosphoric acid. However, the present invention is not limited thereto. Among these anions, preferred is a high molecular or low molecular organic sulfonic acid compound or polyphosphoric acid compound. Preferably, an aromatic sulfonic acid compound (e.g., sodium dodecylbenzenesulfonate, sodium naphthalenesulfonate) is used as the anion-donating compound.

Among the organic sulfonate anions, more effective dopants are a sulfoquinone compound having one or more sulfo-anion group (—SO₃⁻) within the molecule and having a quinone structure, and an anthracene sulfonate anion.

Examples of the fundamental skeleton for the sulfoquinone anion of the above-described sulfoquinone compound include p-benzoquinone, o-benzoquinone, 1,2-naphthoquinone, 1,4-naphthoquinone, 2,6-naphthoquinone, 9,10-anthraquinone, 1,4-anthraquinone, 1,2-anthraquinone, 1,4-chrysenquinone, 5,6-chrysenquinone, 6,12-chrysenquinone, acenaphthoquinone, acenaphthenequinone, camphorquinone, 2,3-bornanedione, 9,10-phenanthrenequinone and 2,7-pyrenequinone.

In the case where the counter electrode is solid, an electrically conducting layer may be provided thereon so as to attain good electrical contact with an exterior leading line (for example, lead frame) which is used, if desired.

The electrically conducting layer can be formed, for example, by the solidification of an electrically conducting paste, the plating, the metallization or the formation of a heat-resistant electrically conducting resin film. Preferred examples of the electrically conducting paste include silver paste, copper paste, aluminum paste, carbon paste and nickel paste, and these may be used individually or in combination of two or more thereof. In the case of using two or more kinds of pastes, the pastes may be mixed or may be superposed one on another as separate layers. The electrically conducting paste applied is then solidified by allowing it to stand in air or under heating. Examples of the plating include nickel plating, copper plating, silver plating and aluminum plating. Examples of the metal vapor-deposited include aluminum, nickel, copper and silver.

More specifically, for example, carbon paste and silver paste are stacked in this order on the second electrode and these are molded with a material such as epoxy resin, thereby manufacturing a capacitor. This capacitor may have a niobium or tantalum lead which is sintered and molded integrally with the niobium monoxide sintered body or welded afterward.

The thus-manufactured capacitor of the present invention is jacketed using, for example, resin mold, resin case, metallic jacket case, dipping of resin or laminate film, and then used as a capacitor product for various uses.

In the case where the counter electrode is liquid, the capacitor manufactured from the above-described two electrodes and a dielectric material is housed, for example, in a can electrically connected to the counter electrode to complete the capacitor. In this case, the electrode side of the niobium monoxide sintered body is guided outside through a niobium or tantalum lead described above and at the same time, insulated from the can using an insulating rubber or the like.

By producing a sintered body for capacitors using the niobium monoxide powder produced according to the embodiment of the present invention described in the foregoing pages and producing a capacitor from the sintered body, a capacitor having a small leakage current and good reliability can be obtained.

The capacitor of the present invention has a larger electrostatic capacitance for the volume than the conventional tantalum capacitors and therefore, a more compact capacitor product can be obtained.

The capacitor of the present invention having such properties can be applied to uses, for example, as a by-pass capacitor or a coupling capacitor which are frequently used in an analogue circuit and a digital circuit, and also to uses of conventional tantalum capacitors.

In general, such a capacitor is frequently used in an electronic circuit and when the capacitor of the present invention is used, the limitation in the arrangement of electronic parts or the discharge of heat can be relieved, as a result, an electronic circuit having high reliability can be disposed in a narrower space than that necessary for conventional electronic circuits.

Furthermore, when the capacitor of the present invention is used, an electronic instrument having smaller size and higher reliability than conventional ones can be obtained, such as computer, computer peripheral equipment (e.g., PC card), mobile equipment (e.g., portable telephone), home appliance, equipment mounted on vehicles, artificial satellite and communication equipment.

### BEST MODE FOR CARRYING OUT THE INVENTION

The present invention is described in detail below by referring to Examples and Comparative Examples, however, the present invention is not limited to these Examples.

In each Example, the tapping density, the angle of repose, the particle size, the pore diameter and the capacitance, leakage current, capacitance appearance ratio and moisture resistance of the capacitor were measured by the following methods.

(1) Measurement of Tapping Density

The tapping density was measured in accordance with the Method by Tapping Apparatus and the Measuring Instrument in the Apparent Specific Gravity Measuring Method of Industrial Sodium Carbonate specified in JIS (Japanese Industrial Standard, Edition of 2000) K1201-1.

(2) Measurement of Angle of Repose

The angle of repose was measured using the flowability measuring instrument and the sample amount specified in JIS (Japanese Industrial Standard, Edition of 2000) Z2504. More specifically, niobium monoxide powder was dropped on a horizontal plane from the hopper lower part at a height of 6 cm from the horizontal plane and the angle of the slant face from the apex of the circular cone generated to the horizontal plane was designated as the angle of repose.

(3) Measurement of Particle Size

Using an apparatus manufactured by Microtrack (HRA 9320-X100), the particle size distribution was measured by the laser diffraction scattering method. A particle size value (D₅₀; μm) when the accumulated volume % corresponded to 50 volume % was designated as the average particle size.

(4) Measurement of Pore Diameter

Using Poresier 9320 manufactured by Micro Meritics, the pore size distribution was measured by the mercury press-fitting method.

In the present invention, the maximal value was determined from the rate of change in the press-fitted amount and by defining the pore diameter shown by the maximal value as the peak top, the maximal value was used as the size of relative intensity of the peak to which this peak top belongs.

(5) Measurement of Capacitance of Capacitor

The LCR meter manufactured by Hewlett-Packard was connected between terminals of the produced chip at room temperature and the measured capacitance at 120 Hz was designated as the capacitance of the capacitor processed into a chip.

(6) Measurement of Leakage Current of Capacitor

The current value measured after a d.c. voltage of 6.3 V was continuously applied between terminals of the produced chip for 1 minute at room temperature was designated as the leakage current value of the capacitor processed into a chip.

(7) Capacitance Appearance Ratio of Capacitor

Assuming that the capacitance when a sintered body electrochemically formed in an aqueous 0.1% phosphoric acid solution for 1,000 minutes under the conditions of 80° C. and 20 V was measured in 30% sulfuric acid was 100%, the capacitance appearance ratio was expressed by the ratio to the capacitance after a capacitor was produced.

(8) Moisture Resistance Value of Capacitor

The moisture resistance value was expressed by the number of units where the capacitance after the produced capacitor was left standing at 60° C. and 95% RH for 500 hours was less than 110% or less than 120% of the initial value. AS the number of units of less than 110% is larger, the moisture resistance value was judged better.

(9) ESR Measured Value of Capacitor

The LCR meter manufactured by Hewlett-Packard was connected between terminals of the produced chip at room temperature and the ESR measured value at 100 kHz, 1.5 VDC and 0.5 Vrms was designated as the ESR of the capacitor processed into a chip.

(10) Content of Each Element of Nitrogen, Oxygen, Sulfur and Carbon

The content was analyzed using an oxygen-nitrogen analyzer or a carbon-sulfur analyzer (both are manufactured by LECO).

(11) Metal Element Content

The content was analyzed using an atomic absorption analyzer, ICP emission analyzer or ICP mass analyzer (all are manufactured by Shimadzu Corporation).

(12) Niobium Oxide Composition

The molar ratio of the oxygen element content measured in (10) above to the niobium element content measured in (11) above was determined and from the value obtained, the x value when the niobium oxide is expressed by NbOx was calculated.

### EXAMPLE 1

A cylindrical stainless steel-made container having an inner diameter of 150 mm and a content volume of 5 liter, with the inside being lined by a tantalum sheet, was prepared. This container was equipped with pipes for feeding or discharging argon, a feeder for powder material, a stirrer, a temperature controller, a heater and a condenser. Into this cylindrical container, 400 g of metal magnesium in the state of shavings was charged and after flashing with argon, heated to 750° C. (reduction temperature). By keeping this temperature for 15 minutes, the metal magnesium was molten and then, the stirrer was started. From the powder feeder, about 10 g of Nb₂O₅ powder was charged. The inner temperature of the reactor rose by about 30° C. After waiting until the inner temperature of the reactor reached the reduction temperature, about 10 g of Nb₂O₅ powder was again charged from the powder feeder. This operation was repeated until addition of 350 g in total of Nb₂O₅ powder was completed. After the completion of addition, the stirring was continued at the reduction temperature for 30 minutes. Subsequently, the reactor was cooled to 10° C. or less, the flashing with argon was stopped, the pressure was reduced and an air was gradually added such that the inner temperature of the reactor did not exceed 50° C. The reaction product was taken out and washed alternately with a mixed aqueous solution of hydrogen peroxide and nitric acid and with ion exchange water. The produced niobium monoxide powder had a composition of NbO_{0.98}.

Into a niobium-made pot, 200 g of this niobium monoxide powder was charged and pulverized for 10 hours by adding thereto water and zirconia balls. The average particle size of the obtained niobium monoxide powder was 1.0 μm. To this slurry, 20 g of butyl polymethylmethacrylate having an average particle size of 1 μm was added and mixed for 1 hour in a shaking mixer. After removing zirconia balls, the mixture was placed in a conical drier and vacuum-dried under the conditions of 1×10² Pa and 80°0 C.

This niobium monoxide powder was heated under 1×10⁻² Pa at 250 to 400° C. for 12 hours to decompose and remove butyl polymethylmethacrylate, and then sintered under reduced pressure of 4×10⁻³ Pa at 1,200° C. for 2 hours. The resulting niobium sintered lump was cooled until the product temperature was lowered to 30° C. or less and after gradually adding air such that the product temperature did not exceed 50° C., the lump was cracked using a roll granulator to obtain a niobium cracked powder having an average particle size of 100 μm.

The physical properties (tapping density, average particle size, angle of repose, BET specific surface area, pore diameter peak top) of this niobium monoxide powder were measured and the values obtained are shown in Table 1.

The thus-obtained niobium monoxide powder (about 0.1 g) was charged into the hopper of a tantalum device automatic molding machine (TAP-2R, manufactured by Seiken) and automatically molded together with a 0.3 mmφ niobium wire to manufacture a molded article having a size of approximately 0.3 cm×0.18 cm×0.45 cm. The outer appearance (chipping, cracking, distortion) and the dispersion in the mass of this molded article are shown in Table 1.

The molded articles was left standing in a vacuum of 4×10⁻³ Pa at 1,400° C. for 30 minutes to obtain a sintered body. 100 Units of this sintered body were prepared and each was electrochemically formed using an aqueous 0.1% phosphoric acid solution at a voltage of 20 V for 200 minutes to form an oxide dielectric film on the surface.

Subsequently, an operation of dipping the sintered body in an aqueous 60% manganese nitrate solution and then heating it at 220° C. for 30 minutes was repeated to form a manganese dioxide layer as the counter electrode layer on the oxide dielectric film. On this counter electrode layer, a carbon layer and a silver paste layer were stacked in this order. After mounting a lead frame thereon, the device as a whole was sealed with an epoxy resin to manufacture a chip-type capacitor. The capacitance appearance ratio of this capacitor, and the average capacitance and average leakage current (hereinafter simply referred to as “LC”) of the chip-type capacitors (n=100 units) are shown in Table 1.

### EXAMPLE 2

In an SUS 304-made reactor, 1,000 g of a niobium ingot was placed and thereinto, hydrogen was continuously introduced at 400° C. for 10 hours. After cooling, the hydrogenated niobium lump was placed in an SUS 304-made pot containing zirconia balls and pulverized for 10 hours. Thereafter, this hydride was formed into a 20 vol % slurry with water, charged together with zirconia balls into a spike mill, and wet-pulverized at 40° C. or less for 7 hours to obtain a pulverized slurry of niobium hydride. After removing zirconia balls, the pulverized slurry was dried under the conditions of 1×10² Pa and 50° C. Subsequently, the obtained niobium hydride powder was heated under 1×10⁻² Pa at 400° C. for 4 hours to dehydrogenate the niobium hydride, and then heated at 200° C. for 5 hours in the presence of air to obtain a niobium monoxide powder having an average particle size of 0.9 μm. The produced niobium monoxide powder had a composition of NbO_{0.88}.

Into a niobium-made pot, 830 g of this niobium monoxide powder and 400 g of toluene were charged and thereto, 170 g of barium oxide having an average particle size of 1 μm was added. Furthermore, zirconia balls were added and the contents were mixed for 1 hour using a shaking mixer. After removing zirconia balls, the mixture was placed in a niobium-made vat and dried under the conditions of 1×10² Pa and 50° C.

Then, the dried mixture was sintered under reduced pressure of 4×10⁻³ Pa at 1,200° C. for 3 hours. The resulting barium oxide-mixed niobium monoxide sintered lump was cooled until the product temperature was lowered to 30° C. or less, and then cracked using a roll granulator to obtain a barium oxide-mixed niobium monoxide cracked powder having an average particle size of 95 μm.

Into a polytetrafluoroethylene-made container, 500 g of this barium oxide-mixed niobium monoxide cracked powder and 1,000 g of ion exchange water were charged and cooled to 15° C. or less. Separately, an aqueous solution obtained by mixing 600 g of 60% nitric acid, 150 g of 30% hydrogen peroxide and 750 g of ion exchange water and cooled to 15° C. or less was prepared. Then, 1,000 g of this aqueous solution was added dropwise with stirring to an aqueous solution having suspended therein the barium oxide-mixed niobium cracked powder while taking care not to allow the water temperature to exceed 20° C. After the completion of dropwise addition, the solution was continuously stirred for another 1 hour, left standing for 30 minutes and then decanted. Thereto, 2,000 g of ion exchange water was added and the resulting solution was stirred for 30 minutes, left standing for 30 minutes and then decanted. This operation was repeated 5 times. Thereafter, the niobium monoxide cracked powder was charged into a Teflon-made column and washed with water for 4 hours while flowing ion exchange water. At this time, the electrical conductivity of the washing water was 0.9 μS/cm.

After the completion of water washing, the niobium monoxide cracked powder was dried at 50° C. under reduced pressure to obtain about 400 g of niobium monoxide powder.

The physical properties of this niobium monoxide powder, such as tapping density, average particle size, angle of repose, BET specific surface area and average pore diameter, are shown in Table 1.

The thus-obtained niobium monoxide powder (about 0.1 g) was charged into the hopper of a tantalum device automatic molding machine (TAP-2R, manufactured by Seiken) and automatically molded together with a 0.3 mmφ niobium wire to manufacture a molded article having a size of approximately 0.3 cm×0.18 cm×0.45 cm. The outer appearance and dispersion in the mass of molded article are shown in Table 1.

This molded article was left standing under reduced pressure of 4×10⁻³ Pa at 1,400° C. for 30 minutes to obtain sintered bodies. 100 Units of this sintered body were prepared and each was electrochemically formed using an aqueous 0.1% phosphoric acid solution at a voltage of 20 V for 200 minutes to form an oxide dielectric film on the surface.

Subsequently, an operation of contacting the oxide dielectric film with an equivalent mixed solution of an aqueous 10% ammonium persulfate solution and an aqueous 0.5% anthraquinonesulfonic acid solution and then with pyrrole vapor was repeated at least 5 times to form a counter electrode comprising polypyrrole on the oxide dielectric film.

On this counter electrode, a carbon layer and a silver paste layer were stacked in this order. After mounting a lead frame thereon, the device as a whole was sealed with an epoxy resin to manufacture a chip-type capacitor. The capacitance appearance ratio of this capacitor and the average capacitance and average LC value of chip-type capacitors (n=100 units) are shown in Table 1.

### EXAMPLES 3 TO 10

Niobium monoxide powders, molded articles thereof, sintered bodies and capacitors were produced in the same manner as in Example 1 except for changing the average particle size and the amount added of butyl polymethylmethacrylate, or in the same manner as in Example 2 except for changing the average particle size and the amount added of barium oxide. The physical properties of niobium monoxide powder, the outer appearance and dispersion in the mass of molded article, and the capacitance and LC of capacitor are shown in Table 1.

### EXAMPLES 11 TO 22

Niobium monoxide powders, molded articles and sintered bodies of Examples 11 to 14 and 16 to 18 were produced in the same manner as in Example 1 and niobium monoxide powders, molded articles and sintered bodies of Examples 15 and 19 to 22 were produced in the same manner as in Examples 2, each except for using the activator shown in Table 1 in place of the butyl polymethylmethacrylate or barium oxide. The physical properties of niobium monoxide powder, and the outer appearance and dispersion in the mass of molded article are shown in Table 1.

These molded articles were then left standing under reduced pressure of 4×10⁻³ Pa at 1,400° C. for 30 minutes to obtain sintered bodies. 100 Units of each sintered body were prepared and electrochemically formed using an aqueous 0.1% phosphoric acid solution at a voltage of 20 V for 200 minutes to form an oxide dielectric film on the surface.

Subsequently, each sintered body having formed thereon a dielectric material was dipped in an aqueous solution containing 25 mass % of ammonium persulfate (Solution 1), pulled up, dried at 80° C. for 30 minutes, dipped in an isopropanol solution containing 18 mass % of 3,4-ethylenedioxythiophene (Solution 2), pulled up and then left standing in an atmosphere of 60° C. for 10 minutes, thereby performing the oxidation polymerization. This sintered body was again dipped in Solution 1 and then treated in the same manner as above. The operation from the dipping in Solution 1 until the oxidation polymerization was repeated 8 times. Then, the sintered body was washed with warm water at 50° C. for 10 minutes and dried at 100° C. for 30 minutes to form a counter electrode comprising electrically conducting poly(3,4-ethylenedioxythiophene).

On this counter electrode, a carbon layer and a silver paste layer were stacked in this order. After mounting a lead frame thereon, the device as a whole was sealed with an epoxy resin to manufacture a chip-type capacitor. The capacitance appearance ratio of this capacitor and the average capacitance and average LC value of chip-type capacitors (n=100 units) are shown in Table 1.

### EXAMPLE 23

Niobium monoxide having an average particle size of 0.9 μm was obtained in the same manner as in Example 1. This niobium monoxide powder had a composition of NbO_{1.02}. Into an alumina-made container, 200 g of this niobium monoxide powder was charged and heated at 300° C. for 2 hours in a nitrogen atmosphere. The obtained starting material niobium monoxide powder contained nitrogen in an amount of 2,100 mass ppm. Using barium oxide as the activator, a nitrogen-containing niobium monoxide cracked powder having an average particle size of 130 μm was obtained in the same manner as in Example 2, and a molded article and a sintered body were produced. The physical properties of niobium monoxide powder and the appearance and dispersion in the mass of molded article are shown in Table 1. Subsequently, a chip-type capacitor was manufactured in the same manner as in Example 22. The capacitance appearance ratio of this capacitor and the average capacitance and average LC value of chip-type capacitors (n=100 units) are shown in Table 1.

### EXAMPLE 24

Niobium monoxide having an average particle size of 0.9 μm was obtained in the same manner as in Example 1. This niobium monoxide powder had a composition of NbO_{1.02}. Then, 200 g of this niobium monoxide powder and 5 g of sulfur powder were thoroughly mixed and charged into platinum-made container. After purging the inside of reactor with argon, the mixture was heated at 250° C. for 2 hours. The obtained starting material niobium monoxide powder contained sulfur in an amount of 2,500 mass ppm. Using barium oxide as the activator, a sulfur-containing niobium monoxide cracked powder having an average particle size of 200 μm was obtained in the same manner as in Example 2, and a molded article and a sintered body were produced. The physical properties of niobium monoxide powder and the appearance and dispersion in the mass of molded article are shown in Table 1. Subsequently, a chip-type capacitor was manufactured in the same manner as in Example 22. The capacitance appearance ratio of this capacitor and the average capacitance and average LC value of chip-type capacitors (n=100 units) are shown in Table 1.

### EXAMPLE 25

Using boron powder, a starting material niobium monoxide powder containing boron was obtained in the same manner as in Example 24. The obtained starting material niobium monoxide powder contained boron in an amount of 1,200 mass ppm. Using barium oxide as the activator, a boron-containing niobium monoxide cracked powder having an average particle size of 80 μm was obtained in the same manner as in Example 2, and a molded article and a sintered body were produced. The physical properties of niobium monoxide powder and the appearance and dispersion in the mass of molded article are shown in Table 1. Subsequently, a chip-type capacitor was manufactured in the same manner as in Example 22. The capacitance appearance ratio of this capacitor and the average capacitance and average LC value of chip-type capacitors (n=100 units) are shown in Table 1. The LC value is a value measured at room temperature by applying a voltage of 6.3 V for 1 minute.

### EXAMPLES 26 TO 29

Niobium monoxide powders were produced in the same manner as in Example 2 except for using, as the starting material, a niobium hydride-neodymium alloy powder in Example 26, a niobium hydride-antimony alloy powder in Example 27, a niobium hydride-ytterbium-boron alloy powder in Example 28, and a niobium hydride-yttrium-zinc alloy powder in Example 29. Each niobium monoxide powder had a composition of NbO_{0.94} in Example 26, NbO_{0.96} in Example 27, NbO_{1.12} in Example 28 and NbO_{1.08} in Example 29, and contained other element. Furthermore, by using the same activator and method as in Example 2, niobium monoxide powders containing other element, having an average particle size of 70 to 250 μm were obtained, and molded articles and sintered bodies were produced. The physical properties of niobium monoxide powder and the appearance and dispersion in the mass of molded article are shown in Table 1. Subsequently, chip-type capacitors were manufactured in the same manner as in Example 2. The capacitance appearance ratio of capacitor and the average capacitance and average LC of chip-type capacitors (n=100 units) are shown in Table 1.

### COMPARATIVE EXAMPLES 1 TO 3

A cylindrical stainless steel-made container having an inner diameter of 150 mm and a content volume of 5 liter, with the inside being lined by a tantalum sheet, was prepared. This container was equipped with pipes for feeding or discharging argon, a feeder for powder material, a stirrer, a temperature controller, a heater and a condenser. Into this cylindrical container, 400 g of metal magnesium in the state of shavings was charged and after flashing with argon, heated to 750° C. (reduction temperature). By keeping this temperature for 15 minutes, the metal magnesium was molten and then, the stirrer was started. From the powder feeder, about 10 g of Nb₂O₅ powder (having an average particle size of 2 to 10 μm) was charged. The inner temperature of the reactor rose by about 30° C. After waiting until the inner temperature of the reactor reached the reduction temperature, about 10 g of Nb₂O₅ powder was again charged from the powder feeder. This operation was repeated until addition of 350 g in total of Nb₂O₅ powder was completed. After the completion of addition, the stirring was continued at the reduction temperature for 30 minutes. Subsequently, the reactor was cooled to 10° C. or less, the flashing with argon was stopped, the pressure was reduced and an air was gradually added such that the inner temperature of the reactor did not exceed 50° C. The reaction product was taken out and washed alternately with a mixed aqueous solution of hydrogen peroxide and nitric acid and with ion exchange water. The produced niobium monoxide powder had a composition of NbO_{1.01} and an average particle size of 1.3 to 7 μm.

The physical properties of niobium monoxide powder, such as tapping density, average particle size, angle of repose, BET specific surface area and average pore diameter, are shown in Table 1.

The thus-obtained niobium monoxide powder (about 0.1 g) was charged into the hopper of a tantalum device automatic molding machine (TAP-2R, manufactured by Seiken) and the automatic molding together with a 0.3 mmφ niobium wire was attempted but failed.

### COMPARATIVE EXAMPLES 4 TO 9

Niobium monoxide powders having a tapping density of 0.2 to 0.4 g/ml or 2.6 to 3.3 g/ml were obtained in the same manner as in Example 2 except for changing the amount added of barium oxide having an average particle size of 1 μm. The physical properties of these powders are shown in Table 1.

Each of the thus-obtained niobium monoxide powders (about 0.1 g) was charged into the hopper of a tantalum device automatic molding machine (TAP-2R, manufactured by Seiken) and automatically molded together with a 0.3 mmφ niobium wire to manufacture molded articles having a size of approximately 0.3 cm×0.18 cm×0.45 cm. The outer appearance and dispersion in the mass of each molded article are shown in Table 1.

These molded articles were left standing in a vacuum of 4×10⁻³ Pa at 1,400° C. for 30 minutes to obtain sintered bodies. 100 Units of each sintered body were prepared and electrochemically formed using an aqueous 0.1% phosphoric acid solution at a voltage of 20 V for 200 minutes to form an oxide dielectric film on the surface.

Subsequently, an operation of contacting the oxide dielectric film with an equivalent mixed solution of an aqueous 10% ammonium persulfate solution and an aqueous 0.5% anthraquinonesulfonic acid solution and then with pyrrole vapor was repeated at least 5 times to form a counter electrode comprising polypyrrole on the oxide dielectric film.

On this counter electrode, a carbon layer and a silver paste layer were stacked in this order. After mounting a lead frame thereon, the device as a whole was sealed with an epoxy resin to manufacture a chip-type capacitor. The capacitance appearance ratio of capacitor and the average capacitance and average LC value of chip-type capacitors (n=100 units) are shown in Table 1.

### EXAMPLE 30

A niobium monoxide powder was obtained in the same manner as in Example 2. This niobium monoxide powder had an average particle size of 0.6 μm and a composition of NbO_{0.95}. Thereto, anhydrous methanol was added to have a slurry concentration of 60 mass % and well suspended. This slurry was charged into a niobium-made pot and thereto, barium oxide having an average particle size of 1.4 μm and 23 μm was added in an amount of 15 mass % and 10 mass %, respectively, based on the niobium monoxide. Furthermore, zirconia balls were added and the contents were mixed for 1 hour using a shaking mixer. After removing zirconia ball, the mixture was placed in a niobium-made vat and dried under the conditions of 1×10² Pa and 50° C.

By the same operation as in Example 2, a barium oxide-mixed niobium monoxide sintered lump and a barium oxide-mixed niobium monoxide cracked powder were obtained.

To 1,000 g of ion exchange water cooled to 15° C. or less, 500 g of the barium oxide-mixed niobium monoxide cracked powder was added with stirring while taking care not to allow the water temperature to exceed 20° C. After the completion of addition, the solution was continuously stirred for another 1 hour, left standing for 30 minutes and then decanted. Thereto, 2,000 g of ion exchange water was added and the resulting solution was stirred for 30 minutes, left standing for 30 minutes and then decanted. This operation was repeated 5 times. Thereafter, the niobium monoxide cracked powder was charged into a Teflon-made column and washed with water for 4 hours while flowing ion exchange water. At this time, the electrical conductivity of the washing water was 0.5 μS/cm.

After the completion of water washing, the niobium monoxide cracked powder was dried at 50° C. under reduced pressure to obtain about 350 g of niobium monoxide powder.

The physical properties of this niobium monoxide powder, such as tapping density, average particle size, angle of repose, BET specific surface area and average pore diameter, are shown in Table 1.

By the same operation as in Example 2, a molded article and a sintered body were produced. The outer appearance and dispersion in the mass of sintered body are shown in Table 1.

Furthermore, by the same operation as in Example 2, a dielectric film was formed, a counter electrode was formed and a carbon layer and a silver paste layer were stacked. After mounting a lead frame thereon, the device as a whole was sealed with an epoxy resin to manufacture a chip-type capacitor. The capacitance appearance ratio of this capacitor and the average capacitance and average LC value of chip-type capacitors (n=100 units) are shown in Table 1.

### EXAMPLES 31 TO 37

Activator-mixed niobium monoxide cracked powders were obtained in the same manner as in Example 30 except for changing the kind of activator added, the two kinds of average particle sizes mixed, and the amounts added. The solvent used for eluting the activator was selected from a solution containing water, an acid, an alkali and ion exchange resin, an ammonium nitrate solution and a solution containing ethylenediaminetetraacetic acid, and the activator was eluted in the same manner as in Example 30 to obtain niobium monoxide powders. The physical properties of each powder are shown in Table 1.

Furthermore, in the same manner as in Example 30, molded articles and sintered bodies were produced and chip-type capacitors were manufactured. The outer appearance and dispersion in the mass of molded article and the average capacitance and average LC of capacitor are shown in Table 1.

### EXAMPLES 38 TO 40

Niobium monoxide powders each containing other component were produced in the same manner as in Example 30 except for using, as the starting material, a niobium hydride-tin alloy powder in Example 38, a niobium-tungsten alloy powder in Example 39, and a niobium-tantalum alloy powder in Example 40. The physical properties of each niobium monoxide powder are shown in Table 1.

Furthermore, in the same manner as in Example 30, molded articles and sintered bodies were produced and chip-type capacitors were manufactured. The outer appearance and dispersion in the mass of molded article and the average capacitance and average LC of capacitor are shown in Table 1.

### EXAMPLES 41 TO 51

Niobium sintered bodies were produced in the same manner as in Example 2 by using niobium monoxide powders produced in Examples 30 to 40. The pore diameter distribution of each sintered body is shown in Table 2.

### EXAMPLES 52 TO 62

100 Units of respective niobium monoxide sintered bodies produced in Examples 41 to 51 were produced and each sintered body was electrochemically formed at 80° C. and 20 V for 1,000 minutes in an aqueous 0.1% phosphoric acid solution to form an oxide dielectric film layer on the surface of sintered body. Then, each sintered body after the electrochemical forming was impregnated with a cathode agent in A shown in Table 5, carbon paste and silver paste were stacked thereon in this order and the device was sealed with an epoxy resin to manufacture a chip-type capacitor. The capacitance appearance ratio and ESR of each capacitor manufactured are shown in Table 3.

### COMPARATIVE EXAMPLES 14 TO 17

100 Units of respective niobium monoxide sintered bodies produced in Comparative Examples 9 to 12 were produced and each sintered body was electrochemically formed at 80° C. and 20 V for 1,000 minutes in an aqueous 0.1% phosphoric acid solution to form an oxide dielectric film layer on the surface of sintered body. Then, each sintered body after the electrochemical forming was impregnated with a cathode agent by the method A shown in Table 5, carbon paste and silver paste were stacked thereon in this order and the device was sealed with an epoxy resin to manufacture a chip-type capacitor. The capacitance appearance ratio and ESR of each capacitor manufactured are shown in Table 3.

### EXAMPLES 63 TO 68

A niobium monoxide primary particle having an average particle size of 0.8 μm was obtained in the same manner as in Example 2. This primary particle was sintered and pulverized to obtain a niobium monoxide granulated powder. Then, 0.1 g of this granulated powder was charged in a metal mold (4.0 mm×3.5 mm×1.8 mm) together with a separately prepared niobium wire having a length of 10 mm and a thickness of 0.3 mm and a load was applied thereto as shown in Table 4 using a tantalum device automatic molding machine (TAP-2R, manufactured by Seiken) to produce molded articles. The molded articles each was then sintered at 1,400° C. for 30 minutes to obtain an objective sintered body. By controlling the load applied of the molding machine, sintered bodies having a pore diameter distribution shown in Table 4 were produced. The size, specific surface area and CV value of the sintered body of Example 63 were 24.7 mm³, 1.1 m²/g and 86,000 μFV/g, respectively. In other Examples, each value was within ±2% of Example 63.

### EXAMPLES 69 TO 71

Sintered bodies were obtained in the same manner as in Examples 63 to 65 except for changing the average particle size of the primary particle to 0.5 μm by classifying the primary particles. The size, specific surface area and CV value of the sintered body of Example 69 were 24.9 mm³, 1.5 m²/g and 126,000 μFV/g, respectively. In other Examples, each value was within ±1% of Example 69. The pore diameter distribution of each sintered body produced is shown in Table 4.

### EXAMPLE 72

A sintered body was obtained in the same manner as in Example 68 except for using a niobium monoxide powder obtained in the same manner as in Example 4 in place of the granulated powder. The size, specific surface area and CV value of the sintered body of Example 72 were 24.8 mm³, 1.2 m²/g and 79,000 μFV/g, respectively. The pore diameter distribution of the sintered body produced is shown in Table 4.

### COMPARATIVE EXAMPLES 10 TO 12

Sintered bodies were produced in the same manner as in Examples 63 to 65 except that a niobium monoxide powder obtained after the heat-treatment at 1,200° C. of a niobium monoxide powder produced by reducing niobium pentaoxide with magnesium was used in place of the niobium monoxide granulated powder used in Examples 63 to 65. The size, specific surface area and CV value of the sintered body of Comparative Example 10 were 24.3 mm³, 0.8 m²/g and 85,000 μFV/g, respectively. In other Examples, each value was within ±2% of Comparative Example 10. The pore diameter distribution of each sintered body produced is shown in Table 4.

### EXAMPLE 73

60 Units of respective sintered bodies produced in the same manner as in Example 30 and Examples 63 to 72 each was electrochemically formed in an aqueous 0.1% phosphoric acid solution at 80° C. and 20 V for 1,000 minutes to form an oxide dielectric film layer on the surface of the sintered body. These sintered bodies after the electrochemical forming were divided into groups each consisting of 30 units. 30 Units of the sintered body in each group were impregnated with either one of two kinds of cathode agents by the method A or B shown in Table 5. Thereon, carbon paste and silver paste were stacked in this order and the device was sealed with an epoxy resin to manufacture a chip-type capacitor. The capacitance appearance ratio and moisture resistance value of each capacitor manufactured are shown in Table 6.

### COMPARATIVE EXAMPLE 13

60 Units of respective sintered bodies produced in the same manner as in Comparative Examples 9 to 12 each was electrochemically formed in an aqueous 0.1% phosphoric acid solution at 80° C. and 20 V for 1,000 minutes to form an oxide dielectric film on the surface of the sintered body. These sintered bodies after the electrochemical forming were divided into groups each consisting of 30 units. 30 Units of the sintered body in each group were impregnated with the cathode agent in A shown in Table 5. Thereon, carbon pate and silver paste were stacked in this order and the device was sealed with an epoxy resin to manufacture a chip-type capacitor. The capacitance appearance ratio and moisture resistance value of each capacitor manufactured are shown in Table 6.

TABLE 1

| | Activator | | |
|---|---|---|---|
| | | | Average |
| | | Amount Added | Particle |
| | Kind | (mass %) | Size (μm) |
| Example 1 | butyl polymethylmethacrylate | 10 | 1.0 |
| Example 2 | BaO | 17 | 1.0 |
| Example 3 | butyl polymethylmethacrylate | 5 | 1.0 |
| Example 4 | butyl polymethylmethacrylate | 1 | 1.0 |
| Example 5 | BaO | 35 | 1.0 |
| Example 6 | BaO | 23 | 1.0 |
| Example 7 | BaO | 20 | 3.0 |
| Example 8 | BaO | 25 | 5.0 |
| Example 9 | BaO | 30 | 9.0 |
| Example 10 | BaO | 40 | 21.0 |
| Example 11 | camphor | 40 | 100 |
| Example 12 | butyl polyacrylate | 18 | 25 |
| Example 13 | polyvinyl alcohol | 15 | 8.0 |
| Example 14 | ZnO | 15 | 3.0 |
| Example 15 | Re₂O₇ | 20 | 6.0 |
| Example 16 | WO₂ | 7 | 2.0 |
| Example 17 | SnO₂ | 10 | 0.8 |
| Example 18 | MgO | 20 | 3.0 |
| Example 19 | Mn(NO₃)₂ | 10 | 2.0 |
| Example 20 | CaCO₃ | 15 | 1.0 |
| | | 5 | 5.0 |
| Example 21 | Y₂O₃ | 15 | 7.5 |
| | B₂O₃ | 15 | 1.0 |
| Example 22 | BaO | 17 | 1.0 |
| Example 23 | BaO | 17 | 1.0 |
| Example 24 | BaO | 15 | 1.5 |
| Example 25 | BaO | 12 | 0.7 |
| Example 26 | BaO | 25 | 3.5 |
| Example 27 | BaO | 20 | 2.5 |
| Example 28 | BaO | 15 | 1.5 |
| Example 29 | BaO | 10 | 0.7 |
| Example 30 | BaO | 15 | 1.4 |
| | | 10 | 23 |
| Example 31 | MgO | 17 | 1.5 |
| | | 15 | 30 |
| Example 32 | CaCO₃ | 20 | 2.5 |
| | | 10 | 17 |
| Example 33 | MgO | 18 | 1.5 |
| | B₂O₃ | 8 | 10 |
| Example 34 | Al₂O₃ | 20 | 2.0 |
| | | 20 | 25 |
| Example 35 | MgO | 15 | 1.0 |
| | Al₂O₃ | 15 | 20 |
| Example 36 | Y₂O₃ | 16 | 2.0 |
| | Al₂O₃ | 9 | 25 |
| Example 37 | MgO | 15 | 1.5 |
| | | 20 | 25 |
| Example 38 | CaCO₃ | 15 | 1.3 |
| | BaO | 10 | 23 |
| Example 39 | BaO | 15 | 1.7 |
| | | 10 | 26 |
| Example 40 | BaO | 15 | 1.7 |
| | MgO | 10 | 30 |
| Comp. Ex. 1 | . . . | . . . | . . . |
| Comp. Ex. 2 | . . . | . . . | . . . |
| Comp. Ex. 3 | . . . | . . . | . . . |
| Comp. Ex. 4 | BaO | 42 | 1.0 |
| Comp. Ex. 5 | BaO | 45 | 1.0 |
| Comp. Ex. 6 | BaO | 55 | 1.0 |
| Comp. Ex. 7 | BaO | 0.8 | 1.0 |
| Comp. Ex. 8 | BaO | 0.6 | 1.0 |
| Comp. Ex. 9 | BaO | 0.4 | 1.0 |

| | Physical Properties of Niobium Powder | | | | |
|---|---|---|---|---|---|
| | Tapping | Average | Angle | BET Speci- | Pore Diam- |
| | Density | Particle | of Re- | fic Surface | eter Peak |
| | (g/ml) | Size (μm) | pose (°) | Ratio (m²/g) | Top (μm) |
| Example 1 | 0.7 | 100 | 42 | 1.5 | 1.2 |
| Example 2 | 1.1 | 95 | 45 | 1.7 | 1.1 |
| Example 3 | 1.2 | 110 | 40 | 1.5 | 1.0 |
| Example 4 | 1.9 | 130 | 38 | 1.3 | 0.8 |
| Example 5 | 0.5 | 85 | 50 | 1.9 | 0.9 |
| Example 6 | 0.8 | 95 | 47 | 1.8 | 1.0 |
| Example 7 | 1.1 | 125 | 45 | 1.7 | 2.9 |
| Example 8 | 1.2 | 140 | 43 | 1.5 | 5.3 |
| Example 9 | 1.5 | 95 | 40 | 1.3 | 8.5 |
| Example 10 | 1.7 | 105 | 37 | 1.0 | 22 |
| Example 11 | 1.8 | 180 | 32 | 1.3 | 95 |
| Example 12 | 1.5 | 250 | 30 | 1.5 | 24 |
| Example 13 | 1.2 | 80 | 49 | 1.4 | 8.1 |
| Example 14 | 1.1 | 75 | 47 | 1.8 | 2.9 |
| Example 15 | 1.1 | 140 | 41 | 1.9 | 5.6 |
| Example 16 | 1.4 | 100 | 46 | 1.7 | 2.1 |
| Example 17 | 1.2 | 90 | 47 | 1.7 | 0.8 |
| Example 18 | 1.1 | 85 | 46 | 1.9 | 2.9 |
| Example 19 | 1.5 | 100 | 44 | 1.6 | 2.3 |
| Example 20 | 1.0 | 90 | 44 | 1.8 | 1.0 |
| | | | | | 5.5 |
| Example 21 | 1.0 | 130 | 44 | 1.7 | 7.8 |
| | | | | | 1.2 |
| Example 22 | 1.2 | 70 | 48 | 1.5 | 1.2 |
| Example 23 | 1.1 | 130 | 45 | 1.7 | 1.1 |
| Example 24 | 1.2 | 200 | 39 | 1.8 | 1.6 |
| Example 25 | 1.1 | 80 | 47 | 1.8 | 0.8 |
| Example 26 | 0.9 | 250 | 39 | 1.7 | 3.4 |
| Example 27 | 1.0 | 90 | 47 | 1.8 | 2.5 |
| Example 28 | 1.1 | 70 | 47 | 1.7 | 1.3 |
| Example 29 | 1.2 | 150 | 41 | 1.8 | 0.7 |
| Example 30 | 0.9 | 100 | 48 | 1.8 | 1.5 |
| | | | | | 25 |
| Example 31 | 1.0 | 130 | 44 | 1.8 | 1.6 |
| | | | | | 33 |
| Example 32 | 1.1 | 160 | 44 | 1.7 | 2.7 |
| | | | | | 18 |
| Example 33 | 1.0 | 115 | 45 | 1.8 | 1.6 |
| | | | | | 12 |
| Example 34 | 0.9 | 150 | 48 | 1.9 | 2.2 |
| | | | | | 23 |
| Example 35 | 0.9 | 130 | 46 | 1.9 | 1.1 |
| | | | | | 22 |
| Example 36 | 1.0 | 95 | 46 | 1.7 | 1.9 |
| | | | | | 26 |
| Example 37 | 0.9 | 135 | 45 | 2.0 | 1.6 |
| | | | | | 24 |
| Example 38 | 0.9 | 85 | 47 | 1.9 | 1.3 |
| | | | | | 22 |
| Example 39 | 0.9 | 110 | 48 | 1.9 | 1.5 |
| | | | | | 24 |
| Example 40 | 0.9 | 130 | 45 | 1.9 | 1.7 |
| | | | | | 29 |
| Comp. Ex. 1 | 2.6 | 1.3 | 77 | 3.2 | 0.7 |
| Comp. Ex. 2 | 2.9 | 2.6 | 73 | 1.8 | 1.9 |
| Comp. Ex. 3 | 3.0 | 7 | 70 | 0.7 | 3.9 |
| Comp. Ex. 4 | 0.4 | 95 | 50 | 1.8 | 0.8 |
| Comp. Ex. 5 | 0.3 | 80 | 58 | 1.9 | 0.8 |
| Comp. Ex. 6 | 0.2 | 55 | 58 | 2.2 | 0.9 |
| Comp. Ex. 7 | 2.6 | 90 | 49 | 1.2 | 0.7 |
| Comp. Ex. 8 | 3.1 | 90 | 49 | 1.0 | 0.6 |
| Comp. Ex. 9 | 3.3 | 105 | 45 | 0.9 | 0.6 |

| | Sintered Body | | | | |
|---|---|---|---|---|---|
| | Outer | | | Electrical | |
| | Appearance: | Dispersion | Cathode | Properties | |
| | chipping, | in Mass | Agent | Capaci- | |
| | cracking, | (g/sintered | Impregnation | tance | LC |
| | distortion | body) | Ratio (%) | (μF) | (μA) |
| Example 1 | none | 0.1 ± 0.002 | 91 | 429 | 14 |
| Example 2 | none | 0.1 ± 0.002 | 90 | 483 | 21 |
| Example 3 | none | 0.1 ± 0.002 | 91 | 427 | 19 |
| Example 4 | none | 0.1 ± 0.002 | 88 | 401 | 17 |
| Example 5 | none | 0.1 ± 0.002 | 89 | 482 | 21 |
| Example 6 | none | 0.1 ± 0.002 | 91 | 483 | 24 |
| Example 7 | none | 0.1 ± 0.002 | 88 | 564 | 26 |
| Example 8 | none | 0.1 ± 0.002 | 90 | 532 | 20 |
| Example 9 | none | 0.1 ± 0.002 | 92 | 439 | 15 |
| Example 10 | none | 0.1 ± 0.002 | 91 | 284 | 7 |
| Example 11 | none | 0.1 ± 0.002 | 89 | 411 | 21 |
| Example 12 | none | 0.1 ± 0.002 | 91 | 401 | 14 |
| Example 13 | none | 0.1 ± 0.002 | 92 | 539 | 25 |
| Example 14 | none | 0.1 ± 0.002 | 88 | 517 | 22 |
| Example 15 | none | 0.1 ± 0.002 | 92 | 512 | 16 |
| Example 16 | none | 0.1 ± 0.002 | 87 | 511 | 17 |
| Example 17 | none | 0.1 ± 0.002 | 92 | 418 | 13 |
| Example 18 | none | 0.1 ± 0.002 | 95 | 609 | 23 |
| Example 19 | none | 0.1 ± 0.002 | 90 | 392 | 16 |
| Example 20 | none | 0.1 ± 0.002 | 94 | 599 | 30 |
| Example 21 | none | 0.1 ± 0.002 | 94 | 447 | 22 |
| Example 22 | none | 0.1 ± 0.002 | 91 | 454 | 15 |
| Example 23 | none | 0.1 ± 0.002 | 92 | 555 | 14 |
| Example 24 | none | 0.1 ± 0.002 | 90 | 501 | 14 |
| Example 25 | none | 0.1 ± 0.002 | 91 | 533 | 14 |
| Example 26 | none | 0.1 ± 0.002 | 89 | 552 | 19 |
| Example 27 | none | 0.1 ± 0.002 | 91 | 561 | 19 |
| Example 28 | none | 0.1 ± 0.002 | 90 | 549 | 17 |
| Example 29 | none | 0.1 ± 0.002 | 89 | 538 | 16 |
| Example 30 | none | 0.1 ± 0.002 | 98 | 595 | 22 |
| Example 31 | none | 0.1 ± 0.002 | 96 | 577 | 22 |
| Example 32 | none | 0.1 ± 0.002 | 96 | 572 | 24 |
| Example 33 | none | 0.1 ± 0.002 | 94 | 551 | 19 |
| Example 34 | none | 0.1 ± 0.002 | 98 | 587 | 24 |
| Example 35 | none | 0.1 ± 0.002 | 98 | 586 | 20 |
| Example 36 | none | 0.1 ± 0.002 | 98 | 584 | 22 |
| Example 37 | none | 0.1 ± 0.002 | 98 | 591 | 20 |
| Example 38 | none | 0.1 ± 0.002 | 98 | 589 | 18 |
| Example 39 | none | 0.1 ± 0.002 | 98 | 585 | 19 |
| Example 40 | none | 0.1 ± 0.002 | 98 | 596 | 24 |
| Comp. Ex. 1 | could not be molded | | — | . . . | . . . |
| Comp. Ex. 2 | could not be molded | | — | . . . | . . . |
| Comp. Ex. 3 | could not be molded | | — | . . . | . . . |
| Comp. Ex. 4 | present | 0.1 ± 0.016 | 90 | 379 | 18 |
| Comp. Ex. 5 | present | 0.1 ± 0.028 | 92 | 402 | 18 |
| Comp. Ex. 6 | present | 0.1 ± 0.048 | 94 | 428 | 17 |
| Comp. Ex. 7 | none | 0.1 ± 0.002 | 40 | 140 | 9 |
| Comp. Ex. 8 | none | 0.1 ± 0.002 | 33 | 112 | 7 |
| Comp. Ex. 9 | none | 0.1 ± 0.002 | 21 | 60 | 5 |

TABLE 2

| | | Pore Diameter Distribution | | |
|---|---|---|---|---|
| | Preparation | Pore | Pore | Peak Having |
| | of Niobium | Diameter of | Diameter of | Larger Relative |
| Examples | Powder | Peak 1, μm | Peak 2, μm | Intensity |
| Example 41 | Example 30 | 0.64 | 3.0 | Peak 2 |
| Example 42 | Example 31 | 0.65 | 3.0 | Peak 2 |
| Example 43 | Example 32 | 0.70 | 2.4 | Peak 2 |
| Example 44 | Example 33 | 0.69 | 2.1 | Peak 2 |
| Example 45 | Example 34 | 0.68 | 2.9 | Peak 2 |
| Example 46 | Example 35 | 0.67 | 2.6 | Peak 2 |
| Example 47 | Example 36 | 0.64 | 2.9 | Peak 2 |
| Example 48 | Example 37 | 0.67 | 2.9 | Peak 2 |
| Example 49 | Example 38 | 0.63 | 2.8 | Peak 2 |
| Example 50 | Example 39 | 0.64 | 2.9 | Peak 2 |
| Example 51 | Example 40 | 0.67 | 3.0 | Peak 2 |

TABLE 3

| | | Capacitance | | |
|---|---|---|---|---|
| | Production of | Appearance | | |
| Example | Sintered Body | Ratio, % | Capacitance | ESR, Ω |
| Example 52 | Example 41 | 98 | 595 | 0.023 |
| Example 53 | Example 42 | 96 | 577 | 0.025 |
| Example 54 | Example 43 | 96 | 572 | 0.024 |
| Example 55 | Example 44 | 94 | 551 | 0.025 |
| Example 56 | Example 45 | 98 | 587 | 0.023 |
| Example 57 | Example 46 | 98 | 586 | 0.023 |
| Example 58 | Example 47 | 98 | 584 | 0.022 |
| Example 59 | Example 48 | 98 | 591 | 0.022 |
| Example 60 | Example 49 | 98 | 589 | 0.021 |
| Example 61 | Example 50 | 98 | 585 | 0.023 |
| Example 62 | Example 51 | 98 | 596 | 0.022 |
| Comparative | Comparative | 21 | 60 | 0.166 |
| Example 14 | Example 9 | | | |
| Comparative | Comparative | 72 | 307 | 0.083 |
| Example 15 | Example 10 | | | |
| Comparative | Comparative | 74 | 315 | 0.083 |
| Example 16 | Example 11 | | | |
| Comparative | Comparative | 69 | 292 | 0.091 |
| Example 17 | Example 12 | | | |

TABLE 4

| | | Pore Distribution | | Peak Having |
|---|---|---|---|---|
| Example and | | Pore | Pore | Larger |
| Comparative | Molding | Diameter of | Diameter of | Relative |
| Example | Load, N | Peak 1, μm | Peak 2, μm | Intensity |
| Example 63 | 451 | 0.64 | 1.02 | Peak 2 |
| Example 64 | 789 | 0.43 | 1.31 | Peak 2 |
| Example 65 | 1130 | 0.29 | 0.78 | Peak 2 |
| Example 66 | 564 | 0.35 | 2.35 | Peak 2 |
| Example 67 | 901 | 0.49 | 0.96 | Peak 2 |
| Example 68 | 337 | 0.52 | 2.89 | Peak 2 |
| Example 69 | 451 | 0.61 | 2.18 | Peak 2 |
| Example 70 | 789 | 0.45 | 2.88 | Peak 2 |
| Example 71 | 1130 | 0.35 | 1.12 | Peak 2 |
| Example 72 | 337 | 0.63 | 2.78 | Peak 2 |
| Comparative | 451 | 0.67 | None | — |
| Example 10 | | | | |
| Comparative | 789 | 0.42 | None | — |
| Example 11 | | | | |
| Comparative | 1130 | 0.25 | None | — |
| Example 12 | | | | |

TABLE 5

| | | Method for Impregnating |
|---|---|---|
| Method | Cathode Agent | Cathode Agent |
| A | polypyrrole | Vapor phase polymerization of |
| | | sintered body having attached |
| | | thereto ammonium persulfate and |
| | | anthraquinonesulfonic acid, with |
| | | pyrrole vapor was repeated. |
| B | mixture of lead dioxide | Dipping of sintered body in a mixed |
| | and lead sulfate (lead | solution of lead acetate and |
| | dioxide: 98 mass %) | ammonium persulfate was repeated. |

TABLE 6

| | | | | Moisture Resistance Value | |
|---|---|---|---|---|---|
| | | Method | Capaci- | Number of | Number of |
| Examples | | of | tance | units having | units having |
| and | Production | Impreg- | Appear- | capaci- | capaci- |
| Compar- | Method of | nating | ance | tance of | tance of |
| ative | Sintered | Cathode | Ratio, | 100% to less | 110% to less |
| Examples | Body | Agent | % | than 110% | than 120% |
| Example | Example 30 | A | 98 | 30/30 | 0/30 |
| 73 | Example 63 | A | 83 | 30/30 | 0/30 |
| | | B | 88 | 30/30 | 0/30 |
| | Example 64 | A | 83 | 30/30 | 0/30 |
| | | B | 86 | 30/30 | 0/30 |
| | Example 65 | A | 79 | 27/30 | 3/30 |
| | Example 66 | A | 83 | 30/30 | 0/30 |
| | Example 67 | A | 81 | 30/30 | 0/30 |
| | Example 68 | A | 80 | 30/30 | 0/30 |
| | Example 69 | A | 86 | 30/30 | 0/30 |
| | Example 70 | A | 82 | 30/30 | 0/30 |
| | Example 71 | A | 79 | 28/30 | 2/30 |
| | Example 72 | A | 96 | 30/30 | 0/30 |
| Compar- | Comparative | A | 21 | 4/30 | 26/30 |
| ative | Example 9 | | | | |
| Example | Comparative | A | 72 | 14/30 | 16/30 |
| 13 | Example 10 | | | | |
| | Comparative | A | 74 | 17/30 | 13/30 |
| | Example 11 | | | | |
| | Comparative | A | 69 | 12/30 | 18/30 |
| | Example 12 | | | | |

### INDUSTRIAL APPLICABILITY

By using a niobium monoxide sintered body preferably having a plurality of pore diameter peak tops in the pore distribution for the capacitor electrode, a high capacitance appearance ratio can be obtained and a capacitor having low leakage current and excellent moisture resistance can be produced. A niobium monoxide powder preferably having a tapping density of 0.5 to 2.5 g/ml, preferably having an average particle size of 10 to 1000 μm is preferred as the material for the above-described sintered body because of its good flowability and capability of continuous molding. When this niobium monoxide powder is used, a capacitor having low leakage current can be stably produced. These niobium monoxide power, sintered body and capacitor and production methods thereof are provided.

1. A niobium monoxide powder for capacitors, being represented by the formula: NbOx (x=0.8 to 1.2) and having a tapping density of 0.5 to 2.5 g/ml.

2. The niobium monoxide powder as claimed in claim 1, which further comprises at least one element selected from the group consisting of magnesium, calcium, strontium, barium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, tantalum, molybdenum, tungsten, manganese, rhenium, ruthenium, osmium, rhodium, iridium, palladium, platinum, silver, gold, zinc, cadmium, mercury, boron, aluminum, gallium, indium, thallium, carbon, silicon, germanium, tin, lead, nitrogen, phosphorus, arsenic, antimony, bismuth, sulfur, selenium and tellurium.

3. The niobium monoxide powder as claimed in claim 1 or 2, wherein the other element forms a composite oxide with niobium.

4. The niobium monoxide powder as claimed in claim 3, wherein the content of the other element is from 50 to 200,000 ppm.

5. The niobium monoxide powder as claimed in claim 1, wherein the average particle size is from 10 to 1,000 μm.

6. The niobium monoxide powder as claimed in claim 1, wherein the angle of repose is from 10 to 60°.

7. The niobium monoxide powder as claimed in claim 1, wherein the BET specific surface area is from 0.5 to 40 m²/g.

8. The niobium monoxide powder as claimed in claim 1, which has a pore distribution having a pore diameter peak top in the range from 0.01 to 500 μm.

9. The niobium monoxide powder as claimed in claim 8, wherein the pore distribution has a plurality of pore diameter peak tops.

10. The niobium monoxide powder as claimed in claim 8 or 9, wherein all of the pore diameter peak tops are in the range from 0.5 to 100 μm.

11. A sintered body using the niobium monoxide powder claimed in any one of claims 1 to 10.

12. The sintered body as claimed in claim 11, which has a pore distribution having a pore diameter peak top in the range from 0.01 to 500 μm.

13. A niobium monoxide sintered body for capacitor electrode, wherein the pore distribution of the niobium monoxide sintered body has a plurality of pore diameter peak tops.

14. The niobium monoxide sintered body as claimed in claim 11 or 13, wherein the pore distribution has two pore diameter peak tops.

15. The niobium monoxide sintered body as claimed in claim 11 or 13, wherein among the plurality of pore diameter peak tops, the peak tops of two peaks having a highest relative intensity are present in the range from 0.2 to 0.7 μm and in the range from 0.7 to 3 μm, respectively.

16. The niobium monoxide sintered body as claimed in claim 11 or 13, wherein among the plurality of pore diameter peak tops, the peak top of the peak having a highest relative intensity is present in the larger diameter side than the peak top of the peak having a next highest relative intensity.

17. The niobium monoxide sintered body as claimed in claim 11 or 13, wherein the sintered body has a volume of 10 mm³ or more including the volume of pore void.

18. The niobium monoxide sintered body as claimed in claim 11 or 13, wherein the sintered body has a specific surface area of 0.2 to 7 m²/g.

19. The niobium monoxide sintered body as claimed in claim 11 or 13, wherein a part of the sintered body is nitrided.

20. The niobium monoxide sintered body as claimed in claim 11 or 13, wherein the sintered body is a sintered body obtained from a niobium monoxide compact of giving a sintered body having a CV value of 40,000 to 200,000 μFV/g when sintered at 1,400° C.

21. A capacitor comprising the niobium monoxide sintered body claimed in any one of claims 11 to 20 as one part electrode, a counter electrode and a dielectric material interposed therebetween.

22. The capacitor as claimed in claim 21, wherein the dielectric material mainly comprises niobium pentaoxide.

23. The capacitor as claimed in claim 21, wherein the counter electrode is at least one material selected from the group consisting of an electrolytic solution, an organic semiconductor and an inorganic semiconductor.

24. The capacitor as claimed in claim 23, wherein the counter electrode is an organic semiconductor and the organic semiconductor is at least one material selected from the group consisting of an organic semiconductor comprising a benzopyrroline tetramer and chloranile, an organic semiconductor mainly comprising tetrathiotetracene, an organic semiconductor mainly comprising tetracyanoquinodimethane, and an electrically conducting polymer.

25. The capacitor as claimed in claim 24, wherein the electrically conducting polymer is at least one member selected from the group consisting of polypyrrole, polythiophene, polyaniline and substitution derivatives thereof.

26. The capacitor as claimed in claim 24, wherein the electrically conducting polymer is an electrically conducting polymer obtained by doping a dopant into a polymer containing a repeating unit represented by the following formula (1) or (2): 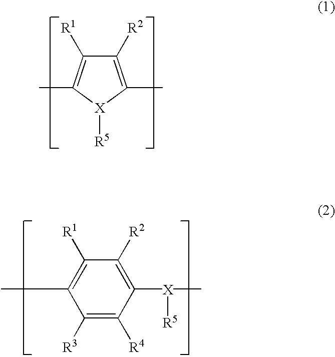
(wherein R¹ to R⁴ each independently represents a monovalent group selected from the group consisting of a hydrogen atom, a linear or branched, saturated or unsaturated alkyl, alkoxy or alkylester group having from 1 to 10 carbon atoms, a halogen atom, a nitro group, a cyano group, a primary, secondary or tertiary amino group, a CF₃ group, a phenyl group and a substituted phenyl group; each of the pairs R¹ and R², and R³ and R⁴ may combine at an arbitrary position to form a divalent chain for forming at least one 3-, 4-, 5-, 6- or 7-membered saturated or unsaturated hydrocarbon cyclic structure together with the carbon atoms substituted by R¹ and R² or by R³ and R⁴; the cyclic combined chain may contain a bond of carbonyl, ether, ester, amide, sulfide, sulfinyl, sulfonyl or imino at an arbitrary position; X represents an oxygen atom, a sulfur atom or a nitrogen atom; R⁵ is present only when X is a nitrogen atom, and independently represents a hydrogen atom or a linear or branched, saturated or unsaturated alkyl group having from 1 to 10 carbon atoms).

27. The capacitor as claimed in claim 26, wherein the electrically conducting polymer is an electrically conducting polymer containing a repeating unit represented by the following formula (3): 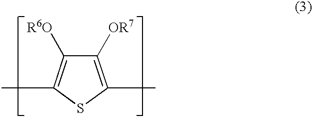
(wherein R⁶ and R⁷ each independently represents a hydrogen atom, a linear or branched, saturated or unsaturated alkyl group having from 1 to 6 carbon atoms, or a substituent for forming at least one 5-, 6- or 7-membered saturated hydrocarbon cyclic structure containing two oxygen elements resulting from the alkyl groups combining with each other at an arbitrary position; and the cyclic structure includes a structure having a vinylene bond which may be substituted, and a phenylene structure which may be substituted).

28. The capacitor as claimed in claim 24, wherein the electrically conducting polymer is an electrically conducting polymer obtained by doping a dopant into poly(3,4-ethylenedioxythiophene).

29. The capacitor as claimed in claim 21, wherein the counter electrode is formed of a material at least partially having a layer structure.

30. The capacitor as claimed in claim 21, wherein the counter electrode is a material containing an organic sulfonate anion as a dopant.

31. A method for producing a niobium monoxide powder, comprising activation-treating niobium monoxide or a niobium monoxide compound to produce the niobium monoxide powder claimed in any one of claims 1 to 10.

32. The method for producing a niobium monoxide powder as claimed in claim 31, wherein the activation treatment of niobium monoxide or niobium monoxide compound is performed in at least one step selected from the group consisting of a sintering step and a cracking step.

33. The method for producing a niobium monoxide powder as claimed in claim 31, wherein the activation treatment of niobium monoxide or niobium monoxide compound is performed using a mixture of niobium monoxide or a niobium monoxide compound and an activator.

34. The method for producing a niobium monoxide powder as claimed in claim 31, wherein the average particle size of the niobium monoxide or niobium monoxide compound subjected to the activation treatment is from 0.01 to 10 μm.

35. The method for producing a niobium monoxide powder as claimed, wherein the niobium monoxide or niobium monoxide compound contains from 50 to 200,000 ppm of at least one element selected from the group consisting of magnesium, calcium, strontium, barium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, tantalum, molybdenum, tungsten, manganese, rhenium, ruthenium, osmium, rhodium, iridium, palladium, platinum, silver, gold, zinc, cadmium, mercury, boron, aluminum, gallium, indium, thallium, carbon, silicon, germanium, tin, lead, nitrogen, phosphorus, arsenic, antimony, bismuth, sulfur, selenium and tellurium.

36. The method for producing a niobium monoxide powder as claimed in claim 35, wherein the other element contained in the niobium monoxide or niobium monoxide compound forms a composite oxide with niobium.

37. The method for producing a niobium monoxide powder as claimed in claim 33, wherein the mixture containing niobium monoxide or a niobium monoxide compound and an activator is obtained by mixing these using a solvent.

38. The method for producing a niobium monoxide powder as claimed in claim 37, wherein the solvent is at least one solvent selected from the group consisting of water, alcohols, ethers, cellosolves, ketones, aliphatic hydrocarbons, aromatic hydrocarbons and halogenated hydrocarbons.

39. The method for producing a niobium monoxide powder as claimed in claim 33, wherein the activator is used in an amount of 1 to 40 mass % based on the total amount of the niobium monoxide or niobium monoxide compound.

40. The method for producing a niobium monoxide powder as claimed in claim 33, wherein the average particle size of the activator is from 0.01 to 500 μm.

41. The method for producing a niobium monoxide powder as claimed in claim 33, wherein the activator has a plurality of particle size peak tops.

42. The method for producing a niobium monoxide powder as claimed in claim 33, wherein the activator is a substance which is removed as a gas at 2,000° C. or less.

43. The method for producing a niobium monoxide powder as claimed in claim 42, wherein the activator is at least one member selected from the group consisting of naphthalene, anthracene, quinone, camphor, polyacrylic acid, polyacrylic acid ester, polyacrylamide, polymethacrylic acid, polymethacrylic acid ester, polymethacrylamide, polyvinyl alcohol, NH₄Cl, ZnO, WO₂, SnO₂ and MnO₃.

44. The method for producing a niobium monoxide powder as claimed in claim 33, wherein the activator is at least one member selected from the group consisting of a water-soluble substance, an organic solvent-soluble substance, an acidic solution-soluble substance, an alkaline solution-soluble substance, a substance of forming a complex and becoming a substance soluble in water, organic solvent, acidic solution or alkaline solution, and a substance of becoming a substance soluble in water, organic solvent, acidic solution or alkaline solution at 2,000° C. or less.

45. The method for producing a niobium monoxide powder as claimed in claim 44, wherein the activator is at least one member selected from the group consisting of compounds of a metal with carbonic acid, sulfuric acid, sulfurous acid, halogen, perhalogen acid, hypohalogen acid, nitric acid, nitrous acid, phosphoric acid, acetic acid, oxalic acid or boric acid, metals, metal hydroxides and metal oxides.

46. The method for producing a niobium monoxide powder as claimed in claim 45, wherein the activator is at least one member selected from the group consisting of metal carbonates, metal hydrogencarbonates, metal hydroxides and metal oxides.

47. The method for producing a niobium monoxide powder as claimed in claim 46, wherein the activator is at least one member selected from the group consisting of metal carbonates, metal hydrogencarbonates, metal hydroxides and metal oxides, and has a melting point higher than the temperature in the sintering step.

48. The method for producing a niobium monoxide powder as claimed in claim 44, wherein the activator is at least one member selected from the group consisting of lithium, sodium, potassium, rubidium, cesium, francium, beryllium, magnesium, calcium, strontium, barium, radium, scandium, yttrium, lanthanum, cerium, praseodymium, neodymium, samarium, europium, gadolinium, terbium, dysprosium, holmium, erbium, thulium, ytterbium, lutetium, titanium, zirconium, hafnium, vanadium, niobium, tantalum, molybdenum, tungsten, manganese, rhenium, ruthenium, osmium, cobalt, rhodium, iridium, nickel, palladium, platinum, silver, gold, zinc, cadmium, boron, aluminum, gallium, indium, thallium, carbon, silicon, germanium, tin, lead, arsenic, antimony, bismuth, selenium, tellurium, polonium and compounds thereof.

49. The method for producing a niobium monoxide powder as claimed in claim 31, wherein the activation treatment is a treatment of performing the removal of the activator by heating and/or under reduced pressure before or during the sintering step.

50. The method for producing a niobium monoxide powder as claimed in claim 31, wherein the activation treatment is a treatment of removing the activator component by contacting a solvent with the sintered or cracked product after the sintering step or during or after the cracking step.

51. The method for producing a niobium monoxide powder as claimed in claim 50, wherein the solvent is at least one member selected from the group consisting of water, an organic solvent, an acidic solution, an alkaline solution and a solution containing a ligand of forming a soluble complex.

52. The method for producing a niobium monoxide powder as claimed in claim 51, wherein the acidic solution is a solution of at least one member selected from the group consisting of nitric acid, sulfuric acid, hydrofluoric acid and hydrochloric acid.

53. The method for producing a niobium monoxide powder as claimed in claim 51, wherein the alkaline solution contains at least one member selected from the group consisting of an alkali metal hydroxide and ammonia.

54. The method for producing a niobium monoxide powder as claimed in claim 51, wherein the ligand is at least one member selected from the group consisting of ammonia, glycine and ethylenediaminetetraacetic acid.

55. A method for producing a nitrogen-containing niobium monoxide powder, comprising treating the niobium monoxide powder claimed in any one of claims 1 to 10 by at least one method selected from the group consisting of liquid nitridation, ion nitridation and gas nitridation.

56. A method for producing a carbon-containing niobium monoxide powder, comprising treating the niobium monoxide powder claimed in any one of claims 1 to 10 by at least one method selected from the group consisting of solid phase carbonization and liquid carbonization.

57. A method for producing a boron-containing niobium monoxide powder, comprising treating the niobium monoxide powder claimed in any one of claims 1 to 10 by at least one method selected from the group consisting of gas boronization and solid phase boronization.

58. A method for producing a sulfur-containing niobium monoxide powder, comprising treating the niobium monoxide powder claimed in any one of claims 1 to 10 by at least one method selected from the group consisting of gas sulfudization, ion sulfudization and solid phase sulfudization.

59. A niobium monoxide powder obtained by the production method described in any one of claims 31 to 58.

60. A method for producing a niobium monoxide sintered body, comprising using the niobium monoxide powder claimed in any one of claims 1 to 10 and 59.

61. A method for producing a capacitor comprising a niobium monoxide sintered body as one part electrode, a dielectric material formed on the surface of the sintered body, and a counter electrode provided on the dielectric material, wherein the niobium monoxide sintered body is obtained by sintering the niobium monoxide powder claimed in any one of claims 1 to 10 and 59.

62. The method for producing a capacitor as claimed in claim 61, wherein the dielectric material is formed by electrolytic oxidation.

63. A method for producing a capacitor comprising a niobium monoxide sintered body as one part electrode, a dielectric material formed on the surface of the sintered body, and a counter electrode provided on the dielectric material, wherein the niobium monoxide sintered body is the niobium monoxide sintered body claimed in any one of claims 11 to 20.

64. An electronic circuit using the capacitor claimed in any one of claims 21 to 30.

65. An electronic instrument using the capacitor claimed in any one of claims 21 to 30.
